(19) United States
(12) Patent Application Publication
(10) Pub. No.: US 2018/0267708 A1
(43) Pub. Date: Sep. 20, 2018

(54) MEMORY SYSTEM AND OPERATING METHOD THEREOF

(71) Applicant: SK hynix Inc., Gyeonggi-do (KR)

(72) Inventor: Beom-Ju SHIN, Gyeonggi-do (KR)

(21) Appl. No.: 15/794,122

(22) Filed: Oct. 26, 2017

(30) Foreign Application Priority Data
Mar. 17, 2017 (KR) 10-2017-0033549

(51) Int. Cl. G06F 3/06; G06F 12/02

(52) U.S. Cl. CPC G06F 3/061; G06F 3/0679; G06F 12/0246; G06F 3/0658; G06F 3/065; G06F 2212/7201; G06F 3/0626

(57) ABSTRACT

A memory system may include: a memory device including a plurality of pages in which data are stored, a plurality of memory blocks in which the pages are included, and a plurality of memory dies in which the memory blocks are included; and a controller suitable for performing command operations corresponding to a plurality of commands received from the host, predicting peak operation durations when performing the command operations, and scheduling the commands by minimizing overlaps between the peak operation durations.

### CROSS-REFERENCE TO RELATED APPLICATION

This application claims priority under 35 U.S.C. § 119 to Korean Patent Application No. 10-2017-0033549 filed on Mar. 17, 2017, the disclosure of which is incorporated herein by reference in its entirety.

### TECHNICAL FIELD

Exemplary embodiments relate to a memory system, and more particularly, to a memory system which processes data with respect to a memory device, and an operating method thereof.

### DISCUSSION OF THE RELATED ART

The computer environment paradigm has changed to ubiquitous computing systems that can be used anytime and anywhere. As a result, use of portable electronic devices such as mobile phones, digital cameras, and notebook computers has rapidly increased. These portable electronic devices generally use a memory system having one or more memory devices for storing data. A memory system may be used as a main or an auxiliary storage device of a portable electronic device.

Memory systems provide excellent stability, durability, high information access speed, and low power consumption because they have no moving parts. Examples of memory systems having such advantages include universal serial bus (USB) memory devices, memory cards having various interfaces, and solid state drives (SSD).

### SUMMARY

Various embodiments of the present invention are directed to a memory system and an operating method thereof, capable of minimizing complexity and performance deterioration of a memory system and maximizing use efficiency of a memory device, thereby quickly and stably processing data with respect to the memory device.

In an embodiment, a memory system may include: a memory device; and a controller suitable for: performing command operations; predicting peak operation durations for each of the command operations when performing the command operations; and scheduling the command operations by minimizing overlaps between the peak operation durations of the command operations.

The controller may be suitable for scheduling the command operations in a manner that the command operations are performed to the memory device with different pending times.

The pending times may correspond to prime numbers times a reference clock of the memory system.

The peak operation durations may be operation durations in which the command operations are performed within at least one of a peak power level and voltage/current level, a peak operation clock and a peak temperature level.

The controller may check the respective command operations, may check respective sub command operations in the respective command operations and may check respective peak sub command operations among the sub command operations of the respective command operations.

The peak operation durations may be operation durations in which the peak sub command operations are respectively performed to the memory device.

The controller may schedule the commands such that the peak sub command operations are performed to the memory device for different operation durations.

The controller may schedule the commands such that the command operations are performed within a maximum usable power level and voltage/current level, a maximum operation clock and a maximum temperature level in the memory system.

The controller may group the memory dies into a plurality of memory die groups, and may schedule the commands such that the command operations are performed with different pending times among the memory die groups or among memory dies in the memory die groups.

The memory die groups may include memory dies which are grouped in correspondence to at least ones among channels, ways, memory block types and data types.

In an embodiment, a method for operating a memory system may include: receiving a plurality of commands for a memory device; predicting peak operation durations when performing command operations; scheduling the commands to minimize overlaps between the peak operation durations; and performing the respective command operations to the memory device.

The scheduling may schedule the commands such that the command operations are performed to the memory device with different pending times.

The pending times may correspond to prime numbers times a reference clock of the memory system.

The peak operation durations may be operation durations in which the command operations are performed within at least one of a peak power level and voltage/current level, a peak operation clock and a peak temperature level.

The method may further include: checking the respective command operations; checking respective sub command operations in the respective command operations; and checking respective peak sub command operations among the sub command operations of the respective command operations.

The peak operation durations may be operation durations in which the peak sub command operations are respectively performed to the memory device.

The scheduling may schedule the commands such that the peak sub command operations are performed to the memory device for different operation durations.

The scheduling may schedule the commands such that the command operations are performed within a maximum usable power level and voltage/current level, a maximum operation clock and a maximum temperature level in the memory system.

The method may further include: grouping the memory dies into a plurality of memory die groups; and scheduling the commands such that the command operations are performed with different pending times among the memory die groups or among memory dies in the memory die groups.

The memory die groups may include memory dies which are grouped in correspondence to at least ones among channels, ways, memory block types and data types.

### BRIEF DESCRIPTION OF THE DRAWINGS

These and other features and advantages of the present invention will become apparent to those skilled in the art to which the present invention pertains from the following detailed description in reference to the accompanying drawings, wherein:

FIG. 1 is a block diagram illustrating a data processing system including a memory system, in accordance with an embodiment of the present invention;

FIG. 2 is a schematic diagram illustrating an exemplary configuration of a memory device employed in the memory system shown in FIG. 1;

FIG. 3 is a circuit diagram illustrating an exemplary configuration of a memory cell array of a memory block in the memory device shown in FIG. 2;

FIG. 4 is a schematic diagram illustrating an exemplary three-dimensional structure of the memory device shown in FIG. 2;

FIG. 5 is a simplified schematic of a memory system comprising a controller and a memory device, in accordance with an embodiment of the present invention;

FIG. 6 is a simplified schematic of a memory device comprising a plurality of dies, planes, blocks and buffers, in accordance with an embodiment of the present invention;

FIG. 7 is a simplified block diagram of a data processing system comprising a memory system operatively coupled to a host, in accordance with an embodiment of the present invention;

FIG. 8 illustrates waive diagrams of an operation of a memory system, in accordance with an embodiment of the present invention.

FIG. 9 is a flow chart illustrating an operation of a memory system, in accordance with an embodiment of the present invention; and

FIGS. 10 to 18 are diagrams schematically illustrating application examples of the data processing system shown in FIG. 1, in accordance with various embodiments of the present invention.

### DETAILED DESCRIPTION

Various embodiments of the present invention are described below in more detail with reference to the accompanying drawings. We note, however, that the present invention may be embodied in different other embodiments, forms and variations thereof and should not be construed as being limited to the embodiments set forth herein. Rather, the described embodiments are provided so that this disclosure will be thorough and complete, and will fully convey the present invention to those skilled in the art to which this invention pertains. Throughout the disclosure, like reference numerals refer to like parts throughout the various figures and embodiments of the present invention.

It will be understood that, although the terms “first”, “second”, “third” and so on may be used herein to describe various elements, these elements are not limited by these terms. These terms are used to distinguish one element from another element. Thus, a first element described below could also be termed as a second or third element without departing from the spirit and scope of the present invention.

The drawings are not necessarily to scale and, in some instances, proportions may have been exaggerated in order to clearly illustrate features of the embodiments.

It will be further understood that when an element is referred to as being “connected to”, or “coupled to” another element, it may be directly on, connected to, or coupled to the other element, or one or more intervening elements may be present. In addition, it will also be understood that when an element is referred to as being “between” two elements, it may be the only element between the two elements, or one or more intervening elements may also be present.

The terminology used herein is for the purpose of describing particular embodiments only and is not intended to be limiting of the present invention. As used herein, singular forms are intended to include the plural forms as well, unless the context clearly indicates otherwise. It will be further understood that the terms “comprises,” “comprising,” “includes,” and “including” when used in this specification, specify the presence of the stated elements and do not preclude the presence or addition of one or more other elements. As used herein, the term “and/or” includes any and all combinations of one or more of the associated listed items.

Unless otherwise defined, all terms including technical and scientific terms used herein have the same meaning as commonly understood by one of ordinary skill in the art to which the present invention belongs in view of the present disclosure. It will be further understood that terms, such as those defined in commonly used dictionaries, should be interpreted as having a meaning that is consistent with their meaning in the context of the present disclosure and the relevant art and will not be interpreted in an idealized or overly formal sense unless expressly so defined herein.

In the following description, numerous specific details are set forth in order to provide a thorough understanding of the present invention. The present invention may be practiced without some or all of these specific details. In other instances, well-known process structures and/or processes have not been described in detail in order not to unnecessarily obscure the present invention.

It is also noted, that in some instances, as would be apparent to those skilled in the relevant art, a feature or element described in connection with one embodiment may be used singly or in combination with other features or elements of another embodiment, unless otherwise specifically indicated.

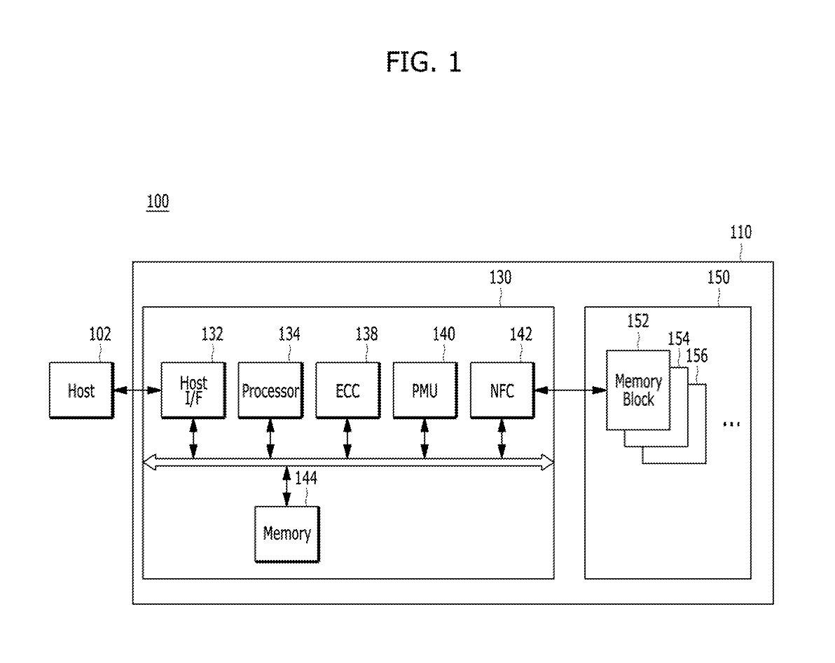

FIG. 1 is a block diagram illustrating a data processing system 100 including a memory system 110 in accordance with an embodiment of the present invention.

Referring to FIG. 1, the data processing system 100 may further include a host 102 operatively coupled to the memory system 110.

The host 102 may include a portable electronic device such as a mobile phone, MP3 player and laptop computer or a non-portable electronic device such as a desktop computer, game machine, TV and projector.

The memory system 110 may operate to store data for the host 102 in response to a request received from the host 102. Non-limited examples of the memory system 110 may include a solid state drive (SSD), a multi-media card (MMC), a secure digital (SD) card, a universal storage bus (USB) device, a universal flash storage (UFS) device, compact flash (CF) card, a smart media card (SMC), a personal computer memory card international association (PCMCIA) card and memory stick. The MMC may include an embedded MMC (eMMC), reduced size MMC (RS-MMC) and micro-MMC. The SD card may include a mini-SD card and micro-SD card.

The memory system 110 may employ various types of storage devices. Non-limited examples of storage devices which may be included in the memory system 110 include volatile memory devices such as a DRAM dynamic random access memory (DRAM) and a static RAM (SRAM) and nonvolatile memory devices such as a read only memory (ROM), a mask ROM (MROM), a programmable ROM (PROM), an erasable programmable ROM (EPROM), an electrically erasable programmable ROM (EEPROM), a ferroelectric RAM (FRAM), a phase-change RAM (PRAM), a magneto-resistive RAM (MRAM), resistive RAM (RRAM) and a flash memory. The flash memory may have a 3-dimensional (3D) stack structure.

The memory system 110 may include a memory device 150 and a controller 130 operatively coupled to each other. The memory device 150 may store data for the host 120 and the con oiler 130 may control data storage into the memory device 150.

The controller 130 and the memory device 150 may be integrated into a single semiconductor device, which may be included in the various types of memory systems as exemplified above.

Non-limited application examples of the memory system 110 may include a computer, an Ultra Mobile PC (UMPC), a workstation, a net-book, a Personal Digital Assistant (PDA), a portable computer, a web tablet, a tablet computer, a wireless phone, a mobile phone, a smart phone, an e-book, a Portable Multimedia Player (PMP), a portable game machine, a navigation system, a black box, a digital camera, a Digital Multimedia Broadcasting (DMB) player, a dimensional television, a smart television, a digital audio recorder, a digital audio player, a digital picture recorder, a digital picture player, a digital video recorder, a digital video player, a storage device constituting a data center, a device capable of transmitting/receiving information in a wireless environment, one of various electronic devices constituting a home network, one of various electronic devices constituting a computer network, one of various electronic devices constituting a telematics network, a Radio Frequency Identification (RFID) device, or one of various components constituting a computing system.

The memory device 150 may be a nonvolatile memory device and may retain data stored therein even though power is not supplied. The memory device 150 may store data provided from the host 102 through a write operation, and provide data stored therein to the host 102 through a read operation. The memory device 150 may include a plurality of memory dies (not shown), each memory die including a plurality of planes (not shown) each plane including a plurality of memory blocks 152 to 156. Each of the memory blocks 152 to 156 may include a plurality of pages, and each of the pages may include a plurality of memory cells coupled to a word line.

The controller 130 may control the memory device 150 in response to a request received from the host 102. For example, the controller 130 may control the read, write (or program) and erase operations of the memory device 150. For example, in a read operation, the controller 130 may provide data read from the memory device 150 to the host 102, and in a write operation the controller may write i.e., store data provided from the host 102 into the memory device 150.

The controller 130 may include a host interface (I/F) unit 132, a processor 134, an error correction code (ECC) unit 138 a Power Management Unit (PMU) 140, a memory device controller (MDC) such as, for example, a NAND flash controller (NFC) 142 and a memory 144 all operatively coupled via an internal bus.

The host interface unit 132 may be configured to process a command and data received from the host 102, and may also transfer data read from the memory device 150 to the host. The host interface unit 132 may communicate with the host 102 through one or more of various interface protocols such as universal serial bus (USB), multi-media card (MMC), peripheral component interconnect-express (PCI-E), small computer system interface (SCSI), serial-attached SCSI (SAS), serial advanced technology attachment (SATA), parallel advanced technology attachment (PATA), enhanced small disk interface (ESDI) and integrated drive electronics (IDE).

The ECC unit 138 may detect and correct an error contained in the data read from the memory device 150. For example, the ECC unit 138 may perform an error correction decoding process to the data read from the memory device 150 through an ECC code used during an ECC encoding process. The ECC unit 138 may output a signal indicating the result of the error correction decoding process. For example, the ECC unit 138 may output an error correction success or an error correction/fail signal. In an embodiment, when the number of error bits is more than a threshold value of correctable error bits, the ECC unit 138 may not correct the error bits, and may output an error correction fail signal.

The ECC unit 138 may perform error correction through any suitable method including, for example, a coded modulation such as Low Density Parity Check LDPC) code, Bose-Chaudhri-Hocquenghem (BCH) code, turbo code, Reed-Solomon code, convolution code, Recursive Systematic Code (RSC), Trellis-Coded Modulation (TCM) and Block coded modulation (BCM). However, the ECC unit 138 is not limited thereto. The ECC unit 138 may include all circuits, modules, systems or devices for the error correction operation.

The PMU 140 may provide and manage the power needs of the controller 130.

The NFC 142 may serve as a memory/storage interface for interfacing the controller 130 and the memory device 150 such that the controller 130 controls the memory device 150 in response to a request received from the host 102. The NFC 142 may work as an interface (e.g., a NAND flash interface) for processing a command and data between the controller 130 and the memory device 150. Specifically, the NFC 142 may support data transfer between the controller 130 and the memory device 150. For example, in an embodiment, the memory device 150 may be a flash memory or specifically a NAND flash memory, and the MDC may be a NAND Flash controller (NFC) 142 and may generate a control signal for the memory device 150 and process data to be provided to the memory device 150 under the control of the processor 134.

The memory 144 may serve as a working memory of the memory system 110 and the controller 130, and store data which may be used for driving the memory system 110 and the controller 130. The controller 130 may control the memory device 150 to perform a read, write, and/or erase operation in response to a request from the host 102. The controller 130 may provide data read from the memory device 150 to the host 102, may store data provided from the host 102 into the memory device 150. The memory 144 may store data required for the controller 130 and the memory device 150 to perform these operations.

The memory 144 may be embodied by a volatile memory. For example, the memory 144 may be embodied by a static random access memory (SRAM) or a dynamic random access memory (DRAM). The memory 144 may be disposed within or out of the controller 130. FIG. 1 exemplifies the memory 144 disposed within the controller 130. In an embodiment, the memory 144 may be embodied by an external volatile memory having a memory interface transferring data between the memory 144 and the controller 130.

The processor 134 may control the overall operations of the memory system 110. The processor 134 may drive firmware to control the overall operations of the memory system 110. The firmware may be referred to as flash translation layer (TL).

The processor 134 of the controller 130 may include a management unit (not illustrated) for performing a bad management operation of the memory device 150. The management unit may perform a bad block management operation of checking a bad block, in which a program fail occurs due to the characteristic of a NAND flash memory during a program operation, among the plurality of memory blocks 152 to 156 included in the memory device 150. The management unit may write the program-failed data of the bad block to a new memory block. In the memory device 150 having a 3D stack structure, the bad block management operation may reduce the use efficiency of the memory device 150 and the reliability of the memory system 110. Thus, the bad block management operation needs to be performed with more reliability.

Also, in a memory system in accordance with an embodiment of the present invention, for instance, in the case where the controller 130 performs a plurality of command operations corresponding to a plurality of commands received from the host 102, for example, a plurality of program operations corresponding to a plurality of write commands, a plurality of read commands corresponding to a plurality of read commands and a plurality of erase commands corresponding to a plurality of erase commands, in the memory device 150, the plurality of commands are scheduled in consideration of a maximum usable power level and voltage/current level in the memory system 110 including the controller 130 and the memory device 150, a maximum operation clock in the memory system 110 and a maximum temperature level in the memory system 110, and then, the plurality of command operations corresponding to the commands are performed in the memory device 150.

In particular, in a memory system in accordance with an embodiment of the present invention, in the case where the controller 130 receives sequentially and successively a plurality of commands from the host 102, by queuing and parsing the respective commands, when performing command operations corresponding to the respective commands sub command operations corresponding to peak power levels and voltage/current levels, peak operation docks and peak temperature levels are checked for the respective command operations to perform the command operations, and operation durations (or operation timings) for (or at) which the sub command operations are to be performed in the respective command operations are predicted. Further, the commands are scheduled such that overlaps between the operation durations (or operation timings) are minimized, and then, the command operations corresponding to the commands are performed in the memory device 150. That is, in the embodiment of the present disclosure, in the case where a plurality of commands are received from the host 102, command operations corresponding to the plurality of commands are performed within a maximum usable power level and voltage/current level in the memory system 110, a maximum operation clock in the memory system 110 and a maximum temperature level in the memory system 110. As a consequence, malfunctions of the command operations may be prevented, the command operations may be stably performed in the memory system 110, and accordingly, the reliability and operational performance of the memory system 110 may be improved.

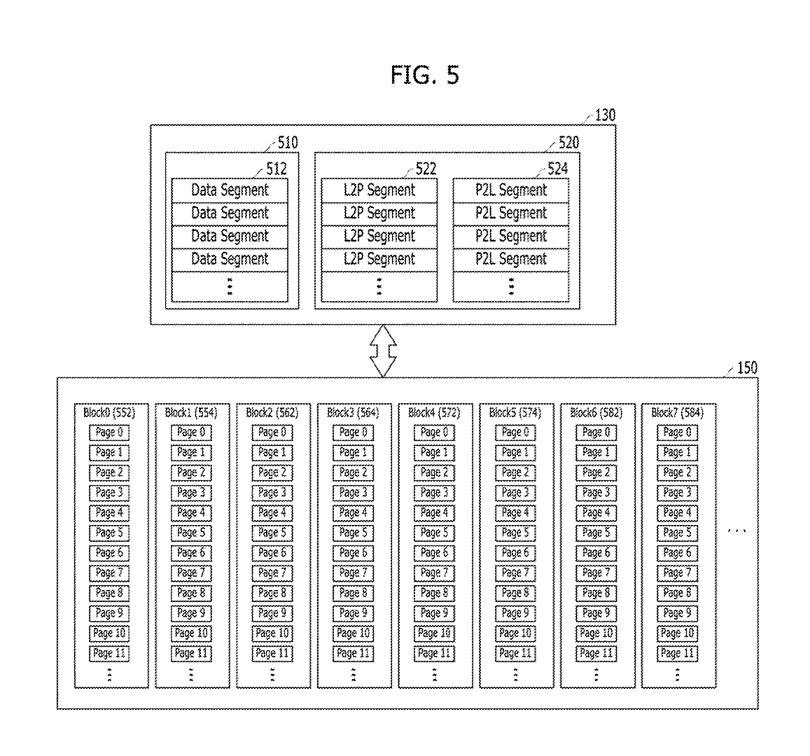

Detailed descriptions will be made below with reference to FIGS. 5 to 9 for the scheduling of a plurality of commands and the performance of a plurality of command operations which correspond to the plurality of commands in the case where the plurality of commands are received from the host 102 in the memory system.

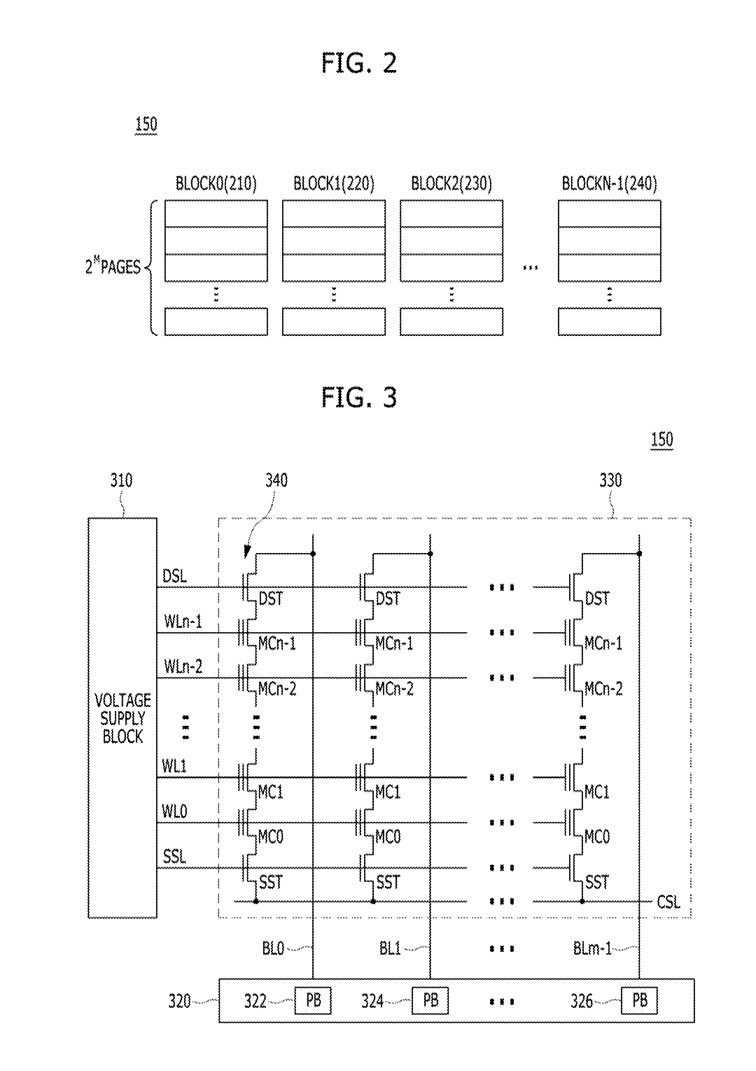

FIG. 2 is a schematic diagram illustrating an exemplary configuration of the memory device 150.

Referring to FIG. 2, the memory device 150 may include a plurality of memory blocks 0 to N-1 and each of the blocks 0 to N-1 may include a plurality of pages, for example, 2^{M} pages, the number of which may vary according to circuit design. Memory cells included in the respective memory blocks 0 to N-1 may be one or more of a single level cell (SLC) storing 1-bit data, or a multi-level cell (MLC) storing 2-bit data. In an embodiment, the memory device 150 may include a plurality of triple level cells (TLC) each storing 3-bit data. In another embodiment, the memory device may include a plurality of quadruple level cells (QLC) each storing 4-bit level cell.

FIG. 3 is a circuit diagram illustrating an exemplary configuration of a memory cell array of a memory block in the memory device 150.

Referring to FIG. 3, a memory block 330 which may correspond to any of the plurality of memory blocks 152 to 156 included in the memory device 150 of the memory system 110 may include a plurality of cell strings 340 coupled to a plurality of corresponding bit lines BL0 to BLm-1. The cell string 340 of each column may include one or more drain select transistors DST and one or more source select transistors SST. Between the drain and source select transistors DST and SST, a plurality of memory cells MC0 to MCn-1 may be coupled in series. In an embodiment, each of the memory cell transistors MC0 to MCn-1 may be an MLC capable of storing data information of a plurality of bits. Each of the cell strings 340 may be electrically coupled to a corresponding bit line among the plurality of bit lines BL0 to BLm-1. For example, as illustrated in FIG. 3, the first cell string is coupled to the first bit line BL0, and the last cell string is coupled to the last bit line BLm-1.

Although FIG. 3 illustrates NAND flash memory cells, the invention is not limited in this way. It is noted that the memory cells may be NOR flash memory cells, or hybrid flash memory cells including two or more kinds of memory cells combined therein. Also, it is noted that the memory device 150 may be a flash memory device including a conductive floating gate as a charge storage layer or a charge trap flash (CTF) memory device including an insulation layer as a charge storage layer.

The memory device 150 may further include a voltage supply unit 310 which provides word line voltages including a program voltage, a read voltage and a pass voltage to supply to the word lines according to an operation mode. The voltage generation operation of the voltage supply unit 310 may be controlled by a control circuit (not illustrated). Under the control of the control circuit, the voltage supply unit 310 may select one of the memory blocks (or sectors) of the memory cell array, select one of the word lines of the selected memory block, and provide the word line voltages to the selected word line and the unselected word lines as may be needed.

The memory device 150 may include a read/write circuit 320 which is controlled by the control circuit. During a verification/normal read operation, the read/write circuit 320 may operate as a sense amplifier for reading data from the memory cell array. During a program operation, the read/write circuit 320 may operate as a write driver for driving bit lines according to data to be stored in the memory cell array. During a program operation, the read/write circuit 320 may receive from a buffer (not illustrated) data to be stored into the memory cell array, and drive bit: lines according to the received data. The read/write circuit 320 may include a plurality of page buffers 322 to 326 respectively corresponding to columns (or bit lines) or column pairs (or bit line pairs), and each of the page buffers 322 to 326 may include a plurality of latches (not illustrated).

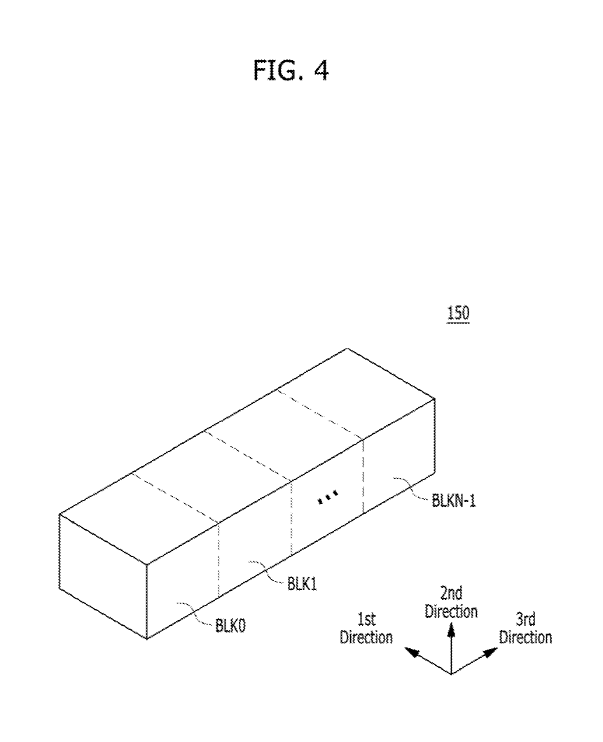

FIG. 4 is a schematic diagram illustrating an exemplary 3D structure of the memory device 150.

The memory device 150 may be embodied by a 2D or 3D memory device. Specifically, as illustrated in FIG. 4, the memory device 150 may be embodied by a nonvolatile memory device having a 3D stack structure. When the memory device 150 has a 3D structure, the memory device 150 may include a plurality of memory blocks BLK0 to BLKN-1 each having a 3D structure (or vertical structure).

Hereinbelow, detailed description will be made with reference to FIGS. 5 to 9, for data processing with respect to the memory device 150 in a memory system in accordance with an embodiment, particularly, a data processing operation in the case of receiving a plurality of commands from the host 102 and performing a plurality of command operations corresponding to the commands.

In the embodiment of the present disclosure, in the case of receiving a plurality of commands from the host 102 and performing a plurality of command operations, according to a maximum usable power level and voltage/current level in the memory system 110 including the controller 130 and the memory device 150, a maximum operation clock in the memory system 110 and a maximum temperature level in the memory system 110, the plurality of commands received from the host 102 are scheduled, and then, the plurality of command operations which correspond to the commands are performed in the memory device 150.

In particular, in the memory system 110, in the case where the controller 130 receives sequentially and successively a plurality of commands from the host 102, the controller may perform queuing and parsing of the respective commands when performing command operations which correspond to the respective commands, and may check the sub command operations corresponding to peak power levels and voltage/current levels, peak operation clocks and peak temperature levels for each of the respective command operations for perform the command operations, and may predict the operation durations (or operation timings) for (or at) which the sub command operations are to be performed in the respective command operations, in particular, peak operation durations (or peak operation timings) in the respective command operations and the sub command operations. Then, the controller may schedule the commands such that overlaps between the operation durations (or operation timings), in particular, the peak operation durations (or peak operation timings), are minimized, and then, may perform the command operations in the memory device 150.

In an embodiment of the present disclosure, the memory system 110 can perform a plurality of command operations corresponding to a plurality of commands received from the host 102, by first checking sub command operations corresponding to peak power levels and voltage/current levels, peak operation clocks and peak temperature levels among the sub command operations of the command operations. These sub command operations are referred to hereinafter also as peak sub command operations. Hence, the memory system 110 of the present invention, according to an embodiment, before performing a plurality of command operations corresponding to a plurality of commands received form the host 102, may check the peak sub command operations for predicting operation durations (or operation timings) for (or at) which the peak sub command operations are to be performed, that is, for predicting peak operation durations (or peak operation timings). Further, the memory system 110 may schedule the performance of the plurality of the received commands in an optimized scheduling sequence that reduces, minimizes or prevents overlaps between the peak operation durations (or peak operation timings) for (or at) which the sub command operations are to be performed. Only then, the command operations corresponding to the received commands may be performed in the memory device 150 according to the optimized scheduling sequence. In this way, in the case where a plurality of commands are received from the host 102, command operations corresponding to the plurality of commands are performed within a maximum usable power level and voltage/current level in the memory system 110, a maximum operation clock in the memory system 110 and a maximum temperature level in the memory system 110. As a consequence, malfunctions of the command operations may be prevented the command operations may be stably performed in the memory system 110 and accordingly, the reliability and operational performance of the memory system 110 are improved substantially.

For example, the controller 130 in the memory system 110 in accordance with an embodiment, may queue and parse a plurality of received write commands from the host 102 such that a plurality of program operations corresponding to the write commands are performed within a maximum usable power level and voltage/current level in the memory system 110, a maximum operation clock in the memory system 110 and a maximum temperature level in the memory system 110. To this end, when performing the program operations, peak sub command operations that is, peak sub program operations, corresponding to peak power levels and voltage/current levels, peak operation docks and peak temperature levels are checked for the respective program operations. Sub command operations, that is, sub program operations, corresponding to the respective program operations may include data transfer operations, data write operations, mapping operations and map update operations for write data in the respective program operations.

In another example, the controller 130 queues and parses, in the case of receiving a plurality of read commands from the host 102, the respective read commands such that a plurality of read operations corresponding to the read commands are performed within a maximum usable power level and voltage/current level in the memory system 110 a maximum operation clock in the memory system 110 and a maximum temperature level in the memory system 110. To this end, when performing the read operations peak sub command operations that is, peak sub read operations, corresponding to peak power levels and voltage/current levels peak operation clocks and peak temperature levels are checked for the respective read operations. Sub read operations corresponding to the respective read operations may include data transfer operations, data sensing operations, map checking operations and data decoding and error correction operations for read data in the respective read operations. In yet another example, the controller 130 queues and parses, in the case of receiving a plurality of erase commands from the host 102, the respective erase commands such that a plurality of erase operations corresponding to the erase commands are performed within a maximum usable power level and voltage/current level in the memory system 110, a maximum operation clock in the memory system 110 and a maximum temperature level in the memory system 110. To this end, when performing the erase operations, peak sub command operations, that is, peak sub erase operations, corresponding to peak power levels and voltage/current levels, peak operation clocks and peak temperature levels are checked for the respective erase operations. Sub erase operations corresponding to the respective erase operations may include corresponding memory block checking operations, data erase operations and map update operations for erase data in the respective erase operations. In yet another example the controller 130 queues and parses, in the case of receiving a plurality of write commands, a plurality of read commands and a plurality of erase commands from the host 102, the respective write commands, read commands and erase commands such that program operations, read operations and erase operations are performed within a maximum usable power level and voltage/current level in the memory system 110, a maximum operation clock in the memory system 110 and a maximum temperature level in the memory system 110. To this end, as described above, peak sub program operations, peak sub read operations and peak sub erase operations corresponding to peak power levels and voltage/current levels, peak operation clocks and peak temperature levels are checked. In this embodiment, the controller 130 predicts operation durations (or operation timings) for (or at) which peak sub command operations, that is, the peak sub program operations, the peak sub read operations and the peak sub erase operations, checked for respective command operations among the command operations corresponding to a plurality of commands received from the host 102, are to be performed as described above, that is, peak operation durations (or peak operation timings) are respectively predicted. Further, the plurality of commands received from the host 102 are scheduled such that overlaps between the peak operation durations (or peak operation timings) for (or at) which the peak sub command operations are to be performed are minimized, and then, the command operations corresponding to the commands are performed in the memory device 150. Therefore, in the memory system 110 in accordance with the embodiment, in the case where a plurality of commands are received from the host 102, command operations corresponding to the plurality of commands are performed within a maximum usable power level and voltage/current level in the memory system 110, a maximum operation clock in the memory system 110 and a maximum temperature level in the memory system 110.

Descriptions will now be made by taking as an example a case where after storing write data corresponding to a plurality of write commands received from the host 102, in the buffers/caches included in the memory 144 of the controller 130, the data stored in the buffers/caches are programmed and stored in the plurality of memory blocks included in the memory device 150, that is, program operations are performed, and, after generating and updating map data in correspondence to the program operations for the memory device 150, the updated map data are stored in the plurality of memory blocks included in the memory device 150, that is, a case where program operations corresponding to a plurality of write commands received from the host 102 are performed. Further, descriptions will be made by taking as an example a case where, when a plurality of read commands are received from the host 102 for the data stored in the memory device 150, data corresponding to the read commands are read from the memory device 150 by checking map data of the data corresponding to the read commands, and, after storing the read data in the buffers/caches included in the memory 144 of the controller 130, the data stored in the buffers/caches are provided to the host 102, that a case where read operations corresponding to a plurality of read commands received from the host 102 are performed. In addition, descriptions will be made by taking as an example a case where, when a plurality of erase commands are received from the host 102 for the memory blocks included in the memory device 150, memory blocks corresponding to the erase commands are checked, data stored in the checked memory blocks are erased, map data are updated in correspondence to the erased data, and the updated map data are stored in the plurality of memory blocks included in the memory device 150, that is, a case where erase operations corresponding to a plurality of erase commands received from the host 102 are performed. Furthermore, in the embodiment of the present disclosure, descriptions will be made by taking as an example a case where the above-described plurality of program operations, read operations and erase operations are performed.

It is further noted that while it is described herein as an example for that the controller 130 performs command operations in the memory system 110, that the processor 134 which is included in the controller 130 may perform a data processing operation through, for example, an FTL (flash translation layer). For example, in an embodiment of the present disclosure, the controller 130 programs and stores user data and metadata corresponding to write commands received from the host 102, in optional memory blocks among the plurality of memory blocks included in the memory device 150, reads user data and metadata corresponding to read commands received from the host 102, from optional memory blocks among the plurality of memory blocks included in the memory device 150, and provides the read data to the host 102, or erases user data and metadata corresponding to erase commands received from the host 102, from optional memory blocks among the plurality of memory blocks included in the memory device 150.

The metadata may include first map data including logical/physical (L2P: logical to physical) information (hereinafter, referred to as a ‘logical information’) and second map data including a physical/logical (P2L: physical to logical) information (hereinafter, referred to as a ‘physical information’), for the data stored in the memory blocks in correspondence to the program operation. Also, the metadata may include an information on the command data corresponding to the command received from the host 102, an information on the command operation corresponding to the command, an information on the memory blocks of the memory device 150 for which the command operation is to be performed, and an information on map data corresponding to the command operation. In other words, the metadata may include all remaining information and data excluding the user data corresponding to the command received from the host 102.

That is, an embodiment of the present disclosure, the controller 130 performs command operations corresponding to a plurality of commands received from the host, that is, performs program operations corresponding to a plurality of write commands, for example, in the case where the write commands are received from the host 102. At this time, the user data corresponding to the write commands are written and stored in the memory blocks of the memory device 150, for example, empty memory blocks, open memory blocks or free memory blocks for which an erase operation is performed, among the memory blocks; and first map data including an L2P map table or an L2P map list in which mapping information between logical addresses and physical addresses for the user data stored in the memory blocks, that is, logical information, are recorded and second map data including a P2L map table or a P2L map list in which mapping information between physical addresses and logical addresses for the memory blocks in which the user data are stored, that is, physical information, are recorded are written and stored in the empty memory blocks, open memory blocks or the free memory blocks among the memory blocks of the memory device 150.

Here, when receiving write commands from the host 102, the controller 130 writes and stores user data corresponding to the write commands in memory blocks, and stores metadata including first map data and second map data for the user data stored in the memory blocks, in memory blocks. In particular, in correspondence to that the data segments of the user data are stored in the memory blocks of the memory device 150, the controller 130 generates and updates the meta segments of the metadata that is, the L2P segments of the first map data and the P2L segments of the second map data as the map segments of map data, and stores the map segments in the memory blocks of the memory device 150. At this time, the controller 130 updates the map segments stored in the memory blocks of the memory device 150, by loading them in the memory 144 of the controller 130.

In particular, in an embodiment of the present disclosure, as described above, in the case where a plurality of write commands are received from the host 102, the write commands are queued and parsed, and peak sub program operations are checked in program operations corresponding to the write commands, for instance, data write operations are checked in the program operations. Then, operation durations (or operation timings) for (or at) which the peak sub program operations are performed, that is, peak operation durations (or peak operation timings) are predicted, the plurality of write commands are scheduled such that overlaps between the peak operation durations (or peak operation timings) for (or at) which the peak sub program operations are to be performed are minimized, and the program operations corresponding to the write commands are performed. In this regard, in the memory system 110 in accordance with the embodiment, in order to perform the program operations within a maximum usable power level and voltage/current level in the memory system 110 including the controller 130 and the memory device 150, a maximum operation dock in the memory system 110 and a maximum temperature level in the memory system 110, the controller 130 schedules the write commands such that overlaps between the operation durations (or operation timings) for (or at) which the peak sub program operations are to be performed, that is, the peak operation durations (or peak operation timings), are minimized that is, schedules the write commands such that timings at which the program operations are to be performed, in particular, timings at which the peak sub program operations are to be performed, have different pending times.

The controller 130 schedules write commands such that program operations, in particular, peak sub program operations are performed with different pending times. According to this fact, among program operations corresponding to a plurality of write commands, for example, a first program operation corresponding to a first write command may be performed at a first timing, a second program operation corresponding to a second write command may be performed at a timing after a first pending time from the first timing, a third program operation corresponding to a third write command may be performed at a timing after a second pending time from the first timing, and a fourth program operation corresponding to a fourth write command may be performed at a timing after a third pending time from the first timing. A pending time may be a prime number times a reference clock (T) of the memory system 110. For instance, the first pending time may be two times the reference clock (T), the second pending time may be three times the reference clock (T), and the third pending time may be five times the reference clock (T). In other words, in the case where the first program operation is performed at a first timing (t0), the second program operation may be performed at a timing corresponding to two reference clocks (2T) after the first timing (t0), the third program operation may be performed at a timing corresponding to three reference docks (T) after the first timing (t0), and the fourth program operation may be performed at a timing corresponding to five reference docks (5T) after the first timing (t0).

Further, in the case where a plurality of read commands are received from the host 102, the controller 130 reads read data corresponding to the read commands, from the memory device 150, stores the read data in the buffers/caches included in the memory 144 of the controller 130, and then, provides the data stored in the buffers/caches, to the host 102, by which read operations corresponding to the plurality of read commands are performed.

In particular, in the embodiment of the present disclosure, as described above, in the case where a plurality of read commands are received from the host 102, the read commands are queued and parsed, and peak sub read operations are checked in read operations corresponding to the read commands, for instance, data decoding and error correction operations are checked In the read operations. Then, operation durations (or operation timings) for (or at) which the peak sub read operations are performed, that is, peak operation durations (or peak operation timings) are predicted, the plurality of read commands are scheduled such that overlaps between the peak operation durations (or peak operation timings) for (or at) which the peak sub read operations are to be performed are minimized, and the read operations corresponding to the read commands are performed. In this regard, in the memory system 110 in accordance with the embodiment, in order to perform the read operations within a maximum usable power level and voltage/current level in the memory system 110 including the controller 130 and the memory device 150, a maximum operation clock in the memory system 110 and a maximum temperature level in the memory system 110, the controller 130 schedules the read commands such that overlaps between the operation durations (or operation timings) for (or at) which the peak sub read operations are to be performed, that is, the peak operation durations (or peak operation timings), are minimized, that is, schedules the read commands such that timings at which the read operations are to be performed, in particular, timings at which the peak sub read operations are to be performed, have different pending times.

That is, the controller 130 schedules read commands such that read operations, in particular, peak sub read operations are performed with different pending times. According to this fact, among read operations corresponding to a plurality of read commands, for example, a first read operation corresponding to a first read command may be performed at a first timing, a second read operation corresponding to a second read command may be performed at a timing after a first pending time from the first timing, a third read operation corresponding to a third read command may be performed at a timing after a second pending time from the first timing and a fourth read operation corresponding to a fourth read command may be performed at a timing after a third pending time from the first timing A pending time may be a prime number times a reference dock (T) of the memory system 110. For instance, the first pending time may be two times the reference dock (T), the second pending time may be three times the reference dock (T), and the third pending time may be five times the reference dock (T). In other words, in the case where the first read operation is performed at a first timing (t0), the second read operation may be performed at a timing corresponding to two reference docks (2T) after the first timing (t0), the third read operation may be performed at a timing corresponding to three reference docks (3T) after the first timing (t0), and the fourth read operation may be performed at a timing corresponding to five reference docks (5T) after the first timing (t0).

In addition, in the case where a plurality of erase commands are received from the host 102, the controller 130 checks memory blocks of the memory device 150 corresponding to the erase commands, and then performs erase operations for the memory blocks.

In particular, in the embodiment of the present disclosure, as described above, in the case where a plurality of erase commands are received from the host 102, the erase commands are queued and parsed, and peak sub erase operations are checked in erase operations corresponding to the erase commands for instance, data erase operations are checked in the erase operations. Then, operation durations (or operation timings) for (or at) which the peak sub erase operations are performed, that is, peak operation durations (or peak operation timings) are predicted, the plurality of erase commands are scheduled such that overlaps between the peak operation durations (or peak operation timings) for (or at) which the peak sub erase operations are to be performed are minimized, and the erase operations corresponding to the erase commands are performed. In this regard, in the memory system 110 in accordance with the embodiment, in order to perform the erase operations within a maximum usable power level and voltage/current level in the memory system 110 including the controller 130 and the memory device 150, a maximum operation clock in the memory system 110 and a maximum temperature level in the memory system 110, the controller 130 schedules the erase commands such that overlaps between the operation durations (or operation timings) for (or at) which the peak sub erase operations are to be performed, that is, the peak operation durations (or peak operation timings) are minimized, that is schedules the erase commands such that timings at which the erase operations are to be performed, in particular, timings at which the peak sub erase operations are to be performed, have different pending times.

That is, the controller 130 schedules erase commands such that erase operations, in particular peak sub erase operations are performed with different pending times. According to this fact, among erase operations, for example, a first erase operation corresponding to a first erase command may be performed at a first timing, a second erase operation corresponding to a second erase command may be performed at a timing after a first pending time from the first timing, a third erase operation corresponding to a third erase command may be performed at a timing after a second pending time from the first timing, and a fourth erase operation corresponding to a fourth erase command may be performed at a timing after a third pending time from the first timing. A pending time may be a prime number times a reference clock (T) of the memory system 110. For instance, the first pending time may be two times the reference dock (T), the second pending time may be three times the reference dock (T), and the third pending time may be five times the reference clock (T). In other words, in the case where the first erase operation is performed at a first timing (t0), the second erase operation may be performed at a timing corresponding to two reference docks (2T) after the first timing (t0), the third erase operation may be performed at a timing corresponding to three reference docks (3T) after the first timing (t0), and the fourth erase operation may be performed at a timing corresponding to five reference clocks (5T) after the first timing (t0).

In this way, in the case where a plurality of commands that is, a plurality of write commands, a plurality of read commands and a plurality of erase commands, are received from the host 102, in particular, in the case where a plurality of commands are received sequentially and successively, the plurality of commands are queued and parsed, peak sub command operations in command operations corresponding to the respective commands are respectively checked, that is, data write operations in program operations, data decoding and error correction operations in read operations and data erase operations in erase operations are checked. Then, operation durations (or operation timings) for (or at) which the peak sub command operations are to be performed, that is, peak operation durations (or peak operation timings) are predicted. Thereafter, the plurality of commands are scheduled such that overlaps between the peak operation durations (or peak operation timings) for (or at) which the peak sub command operations are to be performed are minimized, and the command operations corresponding to the plurality of commands, in particular, the command operations corresponding to the commands received sequentially and successively, that is, the program operations, the read operations and the erase operations are performed. In the memory system 110 in accordance with the embodiment, in order to perform the program operations, the read operations and the erase operations within a maximum usable power level and voltage/current level in the memory system 110 including the controller 130 and the memory device 150, a maximum operation dock in the memory system 110 and a maximum temperature level in the memory system 110 the plurality of commands are scheduled such that overlaps between the operation durations (or operation timings) for (or at) which the peak sub command operations are to be performed, that is, the peak operation durations (or peak operation timings), are minimized, that is, the plurality of commands are scheduled such that timings at which the command operations are to be performed, in particular, timings at which the peak sub command operations are to be performed, have different pending times.

That is to say, in the memory system 110 in accordance with an embodiment, a plurality of commands are scheduled such that command operations, in particular, peak sub command operations, are performed with different pending times. According to this fact, among command operations corresponding to a plurality of commands, for example, a first command operation corresponding to a first command may be performed at a first timing, a second command operation corresponding to a second command may be performed at a timing after a first pending time from the first timing, a third command operation corresponding to a third command may be performed at a timing after a second pending time from the first timing, and a fourth command operation corresponding to a fourth command may be performed at a timing after a third pending time from the first timing. A pending time may be a prime number times a reference clock (T) of the memory system 110. For instance the first pending time may be two times the reference dock (T), the second pending time may be three times the reference dock (T), and the third pending time may be five times the reference dock (T). In other words, in the case where the first command operation is performed at a first timing (t0), the second command operation may be performed at a timing corresponding to two reference clocks (2T) after the first timing (t0), the third command operation may be performed at a timing corresponding to three reference clocks (3T) after the first timing (t0), and the fourth command operation may be performed at a timing corresponding to five reference clocks (5T) after the first timing (to). Hereinbelow, detailed descriptions will be made with reference to FIGS. 5 to 8 for performing of command operations corresponding to a plurality of commands in the memory system in accordance with an embodiment of the present invention.

Referring to FIG. 5, the controller 130 performs command operations, for example, program operations corresponding to a plurality of write commands received from the host 102. At this time, the controller 130 programs and stores user data corresponding to the write commands, in memory blocks 552, 554, 562, 564, 572, 574, 582 and 584 of the memory device 150. Also, in correspondence to the program operation to the memory blocks 552, 554, 562, 564, 572, 574, 582 and 584, the controller 130 generates and updates metadata for the user data and stores the metadata in the memory blocks 552, 554, 562, 564, 572, 574, 582 and 584 of the memory device 150.

More specifically, the controller 130 generates and updates information indicating that the user data are stored in the pages included in the memory blocks 552, 554, 562, 564, 572, 574, 582 and 584 of the memory device 150, for example, first map data and second map data, that is, generates and updates the logical segments of the first map data, that is, L2P segments, and the physical segments of the second map data, that is, P2L segments, and then, stores the L2P segments and the P2L segments in the memory blocks 552, 554, 562, 564, 572, 574, 582 and 584 of the memory device 150.

For example, the controller 130 caches and buffers the user data corresponding to the write commands received from the host 102, in a first buffer 510 included in the memory 144 of the controller 130, that is, stores data segments 512 of the user data in the first buffer 510 as a data buffer/cache. Then, the controller 130 stores the data segments 512 stored in the first buffer 510, in the pages included in the memory blocks 552, 554, 562, 564, 572, 574, 582 and 584 of the memory device 150. As the data segments 512 of the user data corresponding to the write commands received from the host 102 are programmed and stored in the pages included in the memory blocks 552, 554, 562, 564, 572, 574, 582 and 584 of the memory device 150, the controller 130 generates and updates the first map data and the second map data, and stores the first map data and the second map data in a second buffer 520 included in the memory 144 of the controller 130. Namely, the controller 130 stores L2P segments 522 of the first map data for the user data and P2L segments 524 of the second map data for the user data, in the second buffer 520 as a map buffer/cache. In the second buffer 520 in the memory 144 of the controller 130, there may be stored, as described above, the L2P segments 522 of the first map data and the P2L segments 524 of the second map data, or there may be stored a map list for the L2P segments 522 of the first map data and a map list for the P2L segments 524 of the second map data. The controller 130 stores the L2P segments 522 of the first map data and the P2L segments 524 of the second map data which are stored in the second buffer 520 in the pages included in the memory blocks 552, 554, 562, 564, 572 574, 582 and 584 of the memory device 150.

Also, the controller 130 performs command operations corresponding to a plurality of commands received from the host 102, for example, read operations corresponding to a plurality of read commands received from the host 102. At this time, the controller 130 loads the map segments of user data corresponding to the read commands, for example, L2P segments 522 of first map data and P2L segments 524 of second map data, in the second buffer 520, and checks the L2P segments 522 and the P2L segments 524. After that, the controller 130 reads the user data stored in the pages of corresponding memory blocks among the memory blocks 552, 554, 562, 564, 572, 574, 582 and 584 of the memory device 150, stores data segments 512 of the read user data in the first buffer 510, and provides the data segments 512 to the host 102.

Furthermore, the controller 130 performs command operations corresponding to a plurality of commands received from the host 102, for example, erase operations corresponding to a plurality of erase commands received from the host 102. At this time, the controller 130 checks memory blocks corresponding to the erase commands among the memory blocks 552, 554, 562, 564, 572, 574, 582 and 584 of the memory device 150, and performs the erase operations for the checked memory blocks.

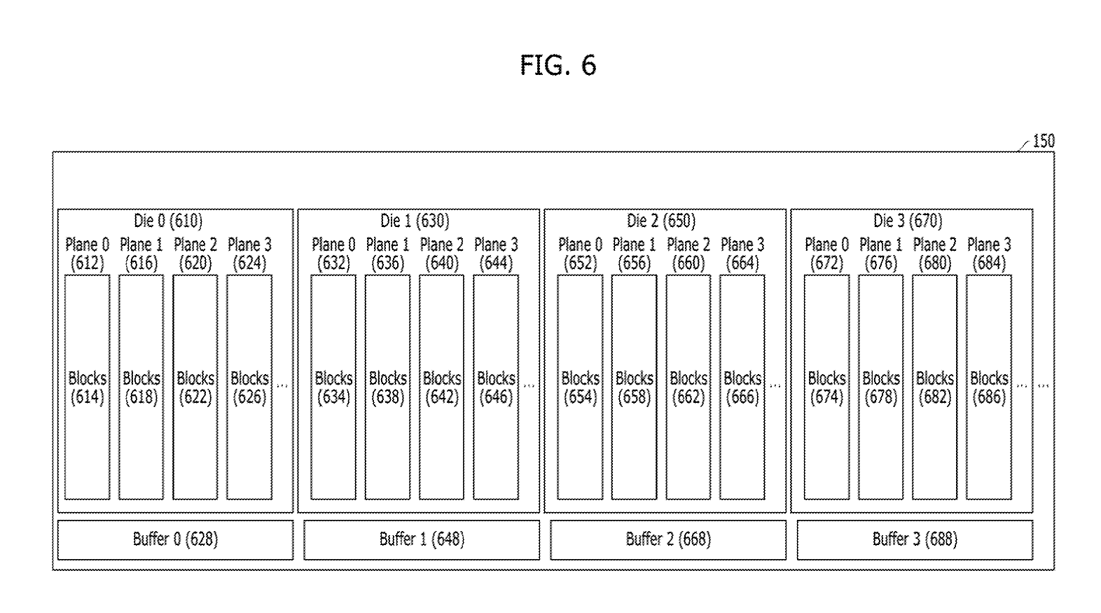

Referring to FIG. 6, the memory device 150 includes a plurality of memory dies, for example, a memory die 0 610, a memory die 1 630, a memory die 2 650 and a memory die 3 670. Each of the memory dies 610, 630, 650 and 670 includes a plurality of planes. For example, the memory die 0 610 includes a plane 0 612, a plane 1 616, a plane 2 620 and a plane 3 624, the memory die 1 630 includes a plane 0 632, a plane 1 636, a plane 2 640 and a plane 3 644, the memory die 2 650 includes a plane 0 652, a plane 1 656, a plane 2 660 and a plane 3 664, and the memory die 3 670 includes a plane 0 672, a plane 1 676, a plane 2 680 and a plane 3 684. The respective planes 612, 616, 620, 624, 632, 636, 640, 644, 652, 656, 660, 664, 672, 676, 680 and 684 in the memory dies 610, 630, 650 and 670 included in the memory device 150 include a plurality of memory blocks 614, 6 8, 622, 626, 634, 638, 642, 646, 654, 658 662, 666, 674, 678, 682 and 686, for example, N number of blocks Block0, Block1, and BlockN-1 each including a plurality of pages, for example, 2̂M number of pages, as described above with reference to FIG. 2. Moreover, the memory device 150 includes a plurality of buffers corresponding to the respective memory dies 610, 630, 650 and 670, for example, a buffer 0 628 corresponding to the memory die 0 610, a buffer 1 648 corresponding to the memory die 1 630, a buffer 2 668 corresponding to the memory die 2 650, and a buffer 3 688 corresponding to the memory die 3 670.

For example, in operation, in the case of performing program operations, data corresponding to the program operations corresponding to a plurality of commands received from the host 102, are first stored in the buffers 628, 648, 668 and 688 and are then stored in the pages included in the memory blocks of the memory dies 610, 630, 650 and 670. In the case of performing read operations, data corresponding to the read operations are read from the pages included in the memory blocks of the memory dies 610, 630, 650 and 670, are stored in the buffers 628 648 668 and 688, and are then provided to the host 102 through the controller 130.

In the embodiment of the present disclosure, while it will be described below as an example for the sake of convenience in explanation that the buffers 628, 648, 668 and 688 included in the memory device 150 exist outside the respective corresponding memory dies 610, 630, 650 and 670, it is to be noted that the buffers 628, 648, 668 and 688 may exist inside the respective corresponding memory dies 610, 630, 650 and 670, and it is to be noted that the buffers 628, 648, 668 and 688 may correspond to the respective planes 612, 616, 620, 624, 632, 636, 640, 644, 652, 656, 660, 664, 672, 676, 680 and 684 or the respective memory blocks 614, 618, 622, 626, 634, 638, 642, 646, 654, 658, 662, 666, 674, 678, 682 and 686 in the respective memory dies 610, 630, 650 and 670. Further, in the embodiment of the present disclosure, while it will be described below as an example for the sake of convenience in explanation that the buffers 628, 648, 668 and 688 included in the memory device 150 are the plurality of page buffers 322, 324 and 326 included in the memory device 150 as described above with reference to FIG. 3, it is to be noted that the buffers 628, 648, 668 and 688 may be a plurality of caches or a plurality of registers included in the memory device 150.

Moreover, in the case where, as described above, the controller 130 performs command operations corresponding to a plurality of commands received from the host 102, in the plurality of memory dies 610, 630, 650 and 670 included in the memory device 150, the memory device 150 in the memory system 110 in accordance with an embodiment may include command registers which receive and store requests to perform command operations corresponding to a plurality of commands transferred from the controller 130, control registers which control performing of the command operations by setting waiting times to the performing of the command operations by pending times for timings at which the command operations are to be performed, depending on scheduling for the commands in the controller 130, and status registers which check and store operation statuses in the plurality of memory dies 610, 630, 650 and 670 included in the memory device 150 for which the command operations are performed, that is, statuses of performing the command operations.

In the memory device 150, there may be included command registers, control registers and status registers respectively corresponding to the plurality of memory dies 610, 630, 650 and 670 included in the memory device 150.That is to say, in the memory device 150, there may be included at least one command register, at least one control register and at least one status register corresponding to the memory die 0 610, at least one command register, at least one control register and at least one status register corresponding to the memory die 1 630, at least one command register, at least one control register and at least one status register corresponding to the memory die 2 650, and at least one command register, at least one control register and at least one status register corresponding to the memory die 3 670.

Also, in an embodiment, waiting time registers may be included in the control registers for setting waiting times for performing the command operations. In another embodiment, the waiting time registers instead of being included in the control registers may be included in the controller 130 of the memory device 150. Also, in an embodiment, the command registers, the control registers and the status registers may be included in the controller 130 instead of being included in the memory device 150.

In an embodiment of the present disclosure, for the sake of convenience in explanation, descriptions will be made by taking an example where the waiting time registers, the command registers, the control registers and the status registers are included in the controller 130.

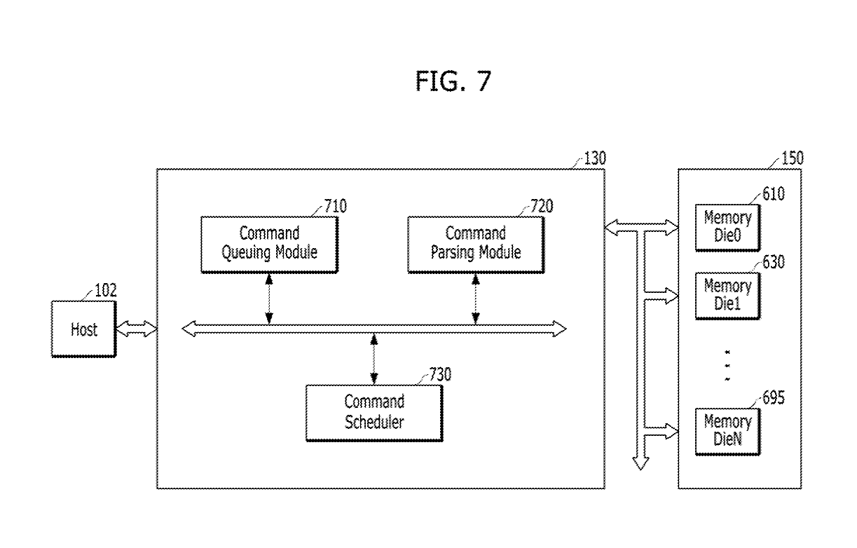

Referring to FIG. 7, the controller 130 receives a plurality of commands, for example, write commands, read commands and/or erase commands, from the host 102. The controller 130 queues the commands through a command queuing module 710, and parses the queued commands through a command parsing module 720. Further, the controller 130 schedules the plurality of commands through a command scheduler 730 such that command operations are performed within a maximum usable power level and voltage/current level in the memory system 110 including the controller 130 and the memory device 150, a maximum operation clock in the memory system 110 and a maximum temperature level in the memory system 110, and then performs the plurality of command operations corresponding to the commands in the memory deice 150.

The command queuing module 710 queues the plurality of commands, for example, the command queuing module 710 may queue a plurality of write commands, read commands and erase commands, received from the host 102 within a predetermined period of time.

The command parsing module 720 parses the queued commands of the command queuing module 710, and thereby, checks command operations corresponding to the queued commands, sub command operations included in the respective command operations and peak sub command operations among the sub command operations of the respective command operations. For example, the command parsing module 720 checks the command operations corresponding to the commands and the sub command operations and the peak sub command operations in the respective command operations, through parsing of the plurality of the queued commands.

The command scheduler 730 of the controller 130 schedules the commands queued in the command queuing module 710, for the plurality of commands received from the host 102, such that the command operations which were checked in the command parsing module 720 are performed in the plurality of memory dies 610, 630, 650 and 670 included in the memory device 150. That is to say, the command scheduler 730 performs scheduling for the plurality of commands received from the host 102. In particular, the command scheduler 730 schedules the plurality of commands in consideration of a maximum usable power level and voltage/current level in the memory system 110 including the controller 130 and the memory device 150, a maximum operation dock in the memory system 110 and a maximum temperature level in the memory system 110.

In detail, the command scheduler 730 schedules the plurality of commands such that the command operations corresponding to the plurality of commands received from the host 102 are performed within a maximum usable power level and voltage/current level in the memory system 110, a maximum operation clock in the memory system 110 and a maximum temperature level in the memory system 110. The command scheduler 730 predicts operation durations (or operation timings) of the checked command operations and the sub command operations and the peak sub command operations in the respective checked command operations. In particular, the command scheduler 730 predicts operation durations (or operation timings) for (or at) which the peak sub command operations in the sub command operations of the respective command operations are respectively performed, that is, peak operation durations (or peak operation timings). The command scheduler 730 schedules the commands such that overlaps between the operation durations (or operation timings) are reduced, minimized, or prevented. At this time, the command scheduler 730 schedules the plurality of commands such that timings at which the command operations are to be performed, in particular, timings at which the peak sub command operations are to be performed, have different pending times.

In other words, the command scheduler 730 schedules the commands such that the command operations, in particular, the peak sub command operations, are performed with different pending times. According to this fact, among the command operations, for example, a first command operation may be performed at a first timing, a second command operation may be performed at a timing after a first pending time from the first timing, a third command operation may be performed at a timing after a second pending time from the first timing, and a fourth command operation may be performed at a timing after a third pending time from the first timing.

A pending time may be a prime number times a reference clock (T) of the memory system 110. For instance, the first pending time may be two times the reference clock (T), the second pending time may be three times the reference clock (T) and the third pending time may be five times the reference clock (T) In the case where the first command operation is performed at a first timing (t0), the second command operation may be performed at a timing corresponding to two reference clocks (2T) after the first timing (t0), the third command operation may be performed at a timing corresponding to three reference docks (3T) after the first timing t0), and the fourth command operation may be performed at a timing corresponding to five reference docks (5T) after the first timing (t0).

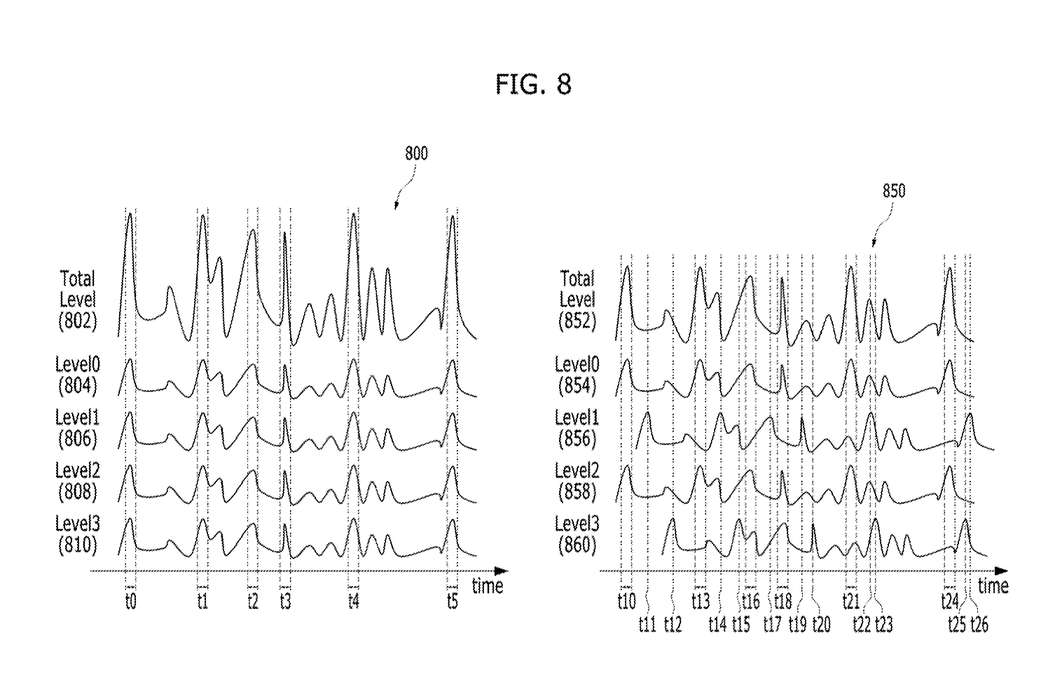

The command scheduler 730 may include command registers, control registers, status registers and waiting time registers, as described above. Namely, the command scheduler 730 may include the waiting time registers for the respective memory dies 610, 630, 650 and 670 to set waiting times to performing of the command operations by different pending times at which the command operations are to be performed, in particular, the timings at which the peak sub command operations are to be performed. Hereinbelow, detailed descriptions will be made with reference to FIG. 8 through an example for performing of the command operations after scheduling the plurality of commands received from the host 102 and for power levels and voltage/current levels in the memory system 110 in correspondence to the performing of the command operations, in the memory system in accordance with the embodiment.

Hereinafter, detailed descriptions will be made by taking as an example a case where four commands are received from the host 102 and command operations corresponding to the four commands are performed in four memory dies included in the memory device 150, for example, the memory die 0 610, the memory die 1 630, the memory die 2 650 and the memory die 3 670.

Referring to FIG. 8, the controller 130 receives four commands from the host 102, and queues and parses the four commands, thereby checking sub command operations in command operations corresponding to the four commands and peak sub command operations in the sub command operations. Further, the controller 130 schedules the four commands such that the queued and parsed command operations are performed within a maximum usable power level and voltage/current level, a maximum operation clock and a maximum temperature level, and then performs the command operations.

In detail, the controller 130 receives first to fourth commands from the host 102, and then, checks first to fourth command operations corresponding to the respective first to fourth commands. Further, the controller 130 checks sub command operations in the respective first to fourth command operations and peak sub command operations among the sub command operations.

For example, the controller 130 checks the first command operation, first sub command operations and a first peak sub command operation, the second command operation, second sub command operations and a second peak sub command operation, the third command operation third sub command operations and a third peak sub command operation, and the fourth command operation, fourth sub command operations and a fourth peak sub command operation.

In the case of performing the first to fourth command operations respectively to the memory dies 0 610, 1 630, 2 650 and 3 670, the controller 130 predicts timings at which the first to fourth command operations are to be performed.

In particular, the controller 130 predicts the first to fourth peak sub command operations among the sub command operations of the first to fourth command operations.

Furthermore, the controller 130 checks a maximum usable power level and voltage/current level, a maximum operation clock and a maximum temperature level. The controller 130 schedules the first to fourth commands, such that the first to fourth command operations are performed in the memory dies 0 610, 1 630, 2 650 and 3 670 within the maximum usable power level and voltage/current level, the maximum operation clock and the maximum temperature level.

In a case 800 where the controller 130 performs the first to fourth command operations to the memory dies 0 610, 1 630, 2 650 and 3 670 without scheduling of the first to fourth commands, levels 804, 806 808 and 810 corresponding to power levels and voltage/current levels, operation docks and temperature levels in the memory dies 0 610, 1 630, 2 650 and 3 670 to which the first to fourth command operations are performed may become peak levels for the same operation durations (or at the same timings), that is, peak levels corresponding to peak power levels and voltage/current levels, peak operation clocks and peak temperature levels. According to this fact, a total level 802 corresponding to power levels and voltage/current levels, operation docks and temperature docks becomes peak levels for the same peak operation durations (or at the same peak timings) corresponding to the memory dies 0 610, 1 630, 2 650 and 3 670.

For instance, as the level 0 804 corresponding to a power level and voltage/current level, an operation clock and a temperature level in the memory die 0 610 for which the first command operation is performed, the level 1 806 corresponding to a power level and voltage/current level, an operation clock and a temperature level in the memory die 1 630 for which the second command operation is performed, the level 2 808 corresponding to a power level and voltage/current level, an operation clock and a temperature level in the memory die 2 650 for which the third command operation is performed and the level 3 810 corresponding to a power level and voltage/current level, an operation clock and a temperature level in the memory die 3 670 for which the fourth command operation is performed become peak levels for (or at) the respective same operation durations (or operation timings) t0, t1, t2, t3, t4 and t5, the peak operation durations (or peak operation timings) of the total level 802 also become the same peak operation durations (or peak operation timings) as the peak operation durations (or peak operation timings) t0, t1, t2, t3, t4 and t5 in the memory dies 610, 630, 650 and 670 for which the command operations are performed. Therefore, the total level 802 of the memory system 110 for (or at) the peak operation durations (or peak operation timings) t0, t1, t2, t3, t4 and t5 may exceed a maximum usable power level and voltage/current level, a maximum operation dock and a maximum temperature level.

Hence, in accordance with an embodiment, the controller 130 schedules the first to fourth commands according to an optimized scheduling sequence, and then performs the first to fourth command operations in the memory dies 0 610, 1 630, 2 650 and 3 670, respectively, according to the optimized scheduling sequence. The controller 130 schedules the first to fourth commands, such that the first to fourth command operations are performed in the memory dies 0 610, 1 630, 2 650 and 3 670 within the maximum usable power level and voltage/current level, the maximum operation clock and the maximum temperature level.

In other words, the controller 130 checks the sub command operations in the first to fourth command operations respectively corresponding to the first to fourth commands, that is the first sub command operations in the first command operation, the second sub command operations in the second command operation, the third sub command operations in the third command operation and the fourth sub command operations in the fourth command operation.

Furthermore, the controller 130 checks the peak sub command operations in the first sub command operations, the second sub command operations, the third sub command operations and the fourth sub command operations, that is, checks the peak sub command operations corresponding to peak power levels and voltage/current levels, peak operation clocks and peak temperature levels in the first to fourth command operations. That is, the controller 130 checks the first peak sub command operation of the first command operation in the first sub command operations, the second peak sub command operation of the second command operation in the second sub command operations, the third peak sub command operation of the third command operation in the third sub command operations, and the fourth peak sub command operation of the fourth command operation in the fourth sub command operations.

In addition, the controller 130 predicts operation durations (or operation timings) for (or at) which the first command operation and the first sub command operations, the second command operation and the second sub command operations, the third command operation and the third sub command operations and the fourth command operation and the fourth sub command operations are performed.

In particular, the controller 130 predicts peak operation durations (or peak operation timings) for (or at) which the first to fourth peak sub command operations are respectively performed.

The controller 130 schedules the first to fourth commands such that overlaps between the peak operation durations (or peak operation timings) are minimized when performing the first to fourth command operations. According to this fact, the first to fourth command operations are respectively performed within the maximum usable power level and voltage/current level, the maximum operation clock and the maximum temperature level.

Through scheduling of the first to fourth commands, the controller 130 causes timings at which the first to fourth command operations, in particular, the first sub peak operation, the second sub peak operation, the third sub peak operation and the fourth sub peak operation are performed, to have different pending times. In other words, the controller 130 schedules the first to fourth commands such that the first to fourth command operations, in particular, the first sub peak operation,the second sub peak operation, the third sub peak operation and the fourth sub peak operation are performed with different pending times corresponding to prime numbers times the reference clock (T) of the memory system 110, for example, pending times corresponding to two times the reference clock (T), three times the reference clock (T) five times the reference clock (T and seven times the reference clock (T).

For instance, the controller 130 schedules the first to fourth commands, and performs the first command operation to the memory die 0 610, the second command operation to the memory die 1 630, the third command operation to the memory die 2 650 and the fourth command operation to the memory die 3 670 (see the reference numeral 850). The controller 130 schedules the first to fourth commands such that overlaps between the peak operation durations (or peak operation timings) are minimized when performing the first to fourth command operations as described above, and thus, the first to fourth command operations are respectively performed with the pending times corresponding to prime numbers times the reference clock (T).

According to this fact, overlaps between the peak operation durations (or peak operation timings) of the first to fourth command operations are minimized. As a consequence, the first to fourth command operations are respectively performed within the maximum usable power level and voltage/current level, the maximum operation clock and the maximum temperature level.

A level 0 854 corresponding to a power level and voltage/current level, an operation clock and a temperature level in the memory die 0 610 for which the first command operation is performed becomes peak operation durations (or peak operation timings) at t10, t13, t16, t18, t21 and t24, a level 1 856 corresponding to a power level and voltage/current level, an operation clock and a temperature level in the memory die 1 630 for which the second command operation is performed becomes peak operation durations (or peak operation timings) at t11, t14, t17, t19, t22 and t26, a level 2 858 corresponding to a power level and voltage/current level an operation dock and a temperature level in the memory die 2 650 for which the third command operation is performed becomes peak operation durations (or peak operation timings) at t10, t13, t16, t18, t21 and t24, and a level 3 860 corresponding to a power level and voltage/current level, an operation clock and a temperature level in the memory die 2 650 for which the fourth command operation is performed becomes peak operation durations (or peak operation timings) at t12, t15, t20, t23 and t25.

Also, the peak operation durations (or peak operation timings) of a total level 852 become the operation durations (or operation timings) t10, t13, t16, t18, t21 and t24. The total level 852 of the memory system 110 at the operation durations (or operation timings) t10, t13, t16, t18, t21 and t24 exist within the maximum usable power level and voltage/current level, the maximum operation clock and the maximum temperature level.

In other words, in accordance with the embodiment, the controller 130 schedules the first to fourth commands, and then performs the first to fourth command operations in the memory dies 0 610, 1 630, 2 650 and 3 670, respectively. In particular, the controller 130 performs the first to fourth command operations in the memory dies 0 610, 1 630, 2 650 and 3 670, respectively, within the maximum usable power level and voltage/current level, the maximum operation clock and the maximum temperature level.

In this way, in accordance with the embodiment, in the case where the plurality of commands are, the command operations are performed within the maximum usable power level and voltage/current level, the maximum operation dock and the maximum temperature level. As a consequence, malfunctions of the command operations may be prevented, the command operations may be stably performed, and accordingly, the reliability and operational performance of the memory system 110 may be improved.

While it was described as an example in the embodiment of the present disclosure that command operations corresponding to commands received from the host 102 are performed in individual memory dies of the memory device 150, it is to be noted that the plurality of memory dies included in the memory device 150 are grouped into memory die groups and command operations may be performed by the memory die groups or by memory dies included in the memory die groups. When performing the command operations in the respective memory die groups, as described above, the controller 130 in the memory system 110 checks sub command operations and peak sub command operations in the command operations, predicts peak operation durations (or peak operation timings) and schedules the commands such that overlaps between the peak operation durations (or peak operation timings) are minimized, for example, schedules the commands such that the command operations, in particular, the peak sub command operations are performed with pending times corresponding to prime numbers times the reference dock (T) of the memory system 110. Also, even when performing the command operations in the memory dies included in the memory die groups, as described above, the controller 130 of the memory system 110 schedules the commands such that overlaps between the peak operation durations (or peak operation timings) are minimized, and then, performs the command operations in the memory dies.

The memory die groups include memory dies which are grouped, in correspondence to channels, ways, memory block types, data types and so forth of the memory dies included in the memory device 150. For example, in the memory die groups, dies which are coupled to the same channels, memory dies which are coupled to the same ways, memory dies in which single level cell memory blocks are included, memory dies in which multi level cell memory blocks, are included, memory dies in which triple level cell memory blocks are included, memory dies in which quadruple level cell memory blocks are included, memory dies in which user data are stored, memory dies in which metadata data are stored, memory dies in which hot data or random data are stored, and memory dies in which cold data or sequential data are stored by being grouped respectively.

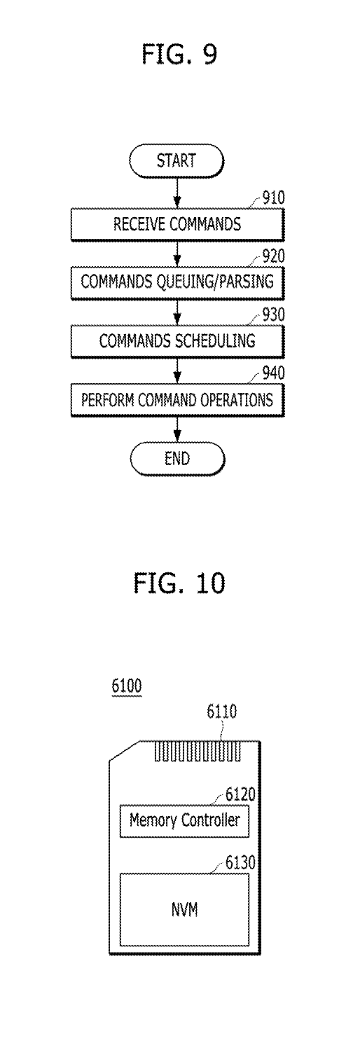

FIG. 9 is a flow chart illustrating an operation of the memory system 110.

Referring to FIG. 9, at step 910, the memory system 110 receives a plurality of commands from the host 102. The memory system 110 may receive the plurality of commands sequentially and successively from the host 102.

At step 920, the plurality of commands are queued and parsed. Command operations, sub command operations included in the respective command operations, and peak sub command operations in the sub command operations of the respective command operations are checked.

Then, at step 930, operation durations (or operation timings) for (or at) which the sub command operations are to be performed in the respective command operations are predicted, and the commands are scheduled such that overlaps between the operation durations (or operation timings) are minimized. In particular, operation durations (or operation timings) of the peak sub command operations in the respective command operations, that is, peak operation durations (or peak operation timings) are predicted, and then, the commands are scheduled such that overlaps between the peak operation durations (or peak operation timings) are minimized. The commands are scheduled such that the peak sub command operations in the respective command operations are performed in the memory dies with pending times corresponding to prime numbers times the reference clock of the memory system 110.

At step 940, the command operations are performed in the memory dies with pending times corresponding to prime numbers times the reference dock of the memory system 110. At this time, the command operations are respectively performed within a maximum usable power level and voltage/current level a maximum operation dock and a maximum temperature level.

FIGS. 10 to 18 are diagrams schematically illustrating application examples of the data processing system of FIG. 1.

FIG. 10 is a diagram schematically illustrating another example of the data processing system including the memory system in accordance with the present embodiment. FIG. 10 schematically illustrates a memory card system to which the memory system in accordance with the present embodiment is applied.

Referring to FIG. 10, the memory card system 6100 may include a memory controller 6120, a memory device 6130 and a connector 6110.

More specifically, the memory controller 6120 may be connected to the memory device 6130 embodied by a nonvolatile memory, and configured to access the memory device 6130. For example, the memory controller 6120 may be configured to control read, write, erase and background operations of the memory device 6130. The memory controller 6120 may be configured to provide an interface between the memory device 6130 and a host, and drive firmware for controlling the memory device 6130. That is, the memory controller 6120 may correspond to the controller 130 of the memory system 110 described with reference to FIGS. 1 to 9, and the memory device 6130 may correspond to the memory device 150 of the memory system 110 described with reference to FIGS. 1 to 9.

Thus, the memory controller 6120 may include a RAM, a processing unit, a host interface, a memory interface and an error correction unit. The memory controller 130 may further include the elements shown in FIG. 5.

The memory controller 6120 may communicate with an external device, for example, the host 102 of FIG. 1 through the connector 6110. For example, as described with reference to FIG. 1, the memory controller 6120 may be configured to communicate with an external device through one or more of various communication protocols such as universal serial bus (USB), multimedia card (MMC), embedded MMC (eMMC), peripheral component interconnection (PCI), PCI express (PCIe), Advanced Technology Attachment (ATA), Serial-ATA, Parallel-ATA, small computer system interface (SCSI), enhanced small disk interface (EDSI), Integrated Drive Electronics (IDE), Firewire, universal flash storage (UFS), WIFI and Bluetooth. Thus, the memory system and the data processing system in accordance with the present embodiment may be applied to wired/wireless electronic devices or particularly mobile electronic devices.

The memory device 6130 may be implemented by a nonvolatile memory. For example, the memory device 6130 may be implemented by various nonvolatile memory devices such as an erasable and programmable ROM (EPROM), an electrically erasable and programmable ROM (EEPROM), a NAND flash memory, a NOR flash memory a phase-change RAM (PRAM), a resistive RAM (ReRAM) a ferroelectric RAM (FRAM) and a spin torque transfer magnetic RAM (STT-RAM). The memory device 6130 may include a plurality of dies as in the memory device 150 of FIG. 5.

The memory controller 6120 and the memory device 6130 may be integrated into a single semiconductor device. For example, the memory controller 6120 and the memory device 6130 may construct a solid state driver (SSD) by being integrated into a single semiconductor device. Also, the memory controller 6120 and the memory device 6130 may construct a memory card such as a PC card (PCMCIA: Personal Computer Memory Card International Association), a compact flash (CF) card, a smart media card (e.g., SM and SMC), a memory stick, a multimedia card (e.g., MMC, RS-MMC, MMCmicro and eMMC), an SD card (e.g., SD, miniSD, microSD and SDHC) and a universal flash storage (UFS).

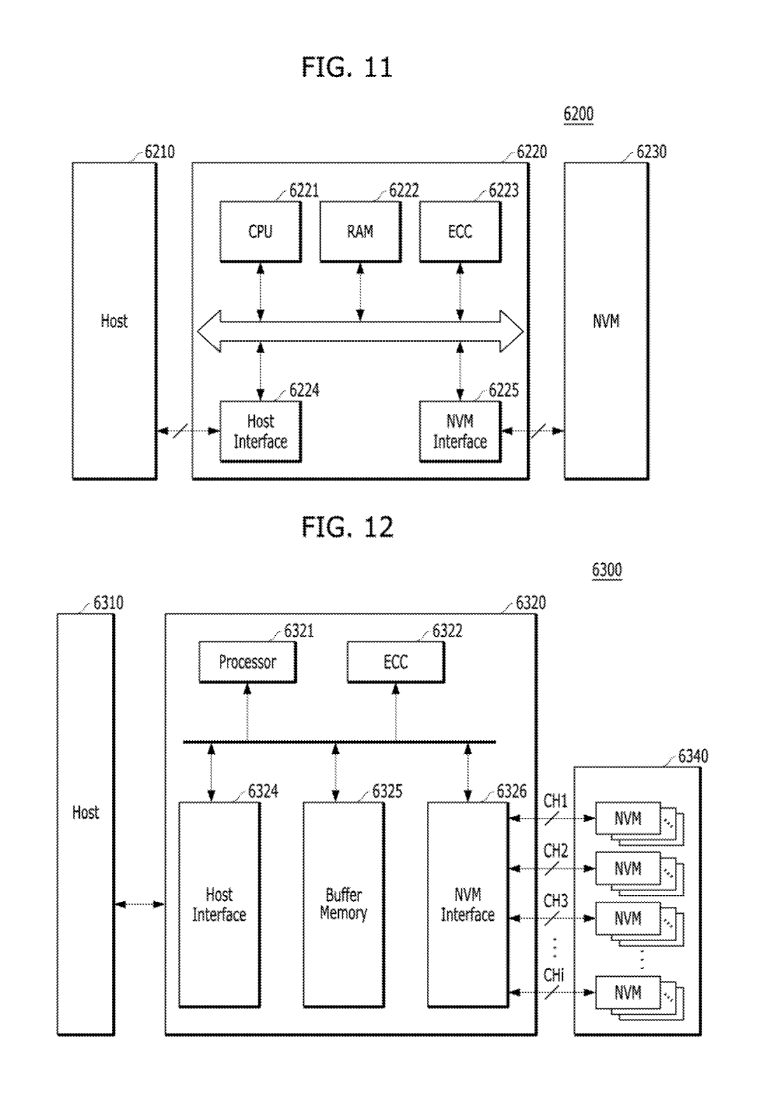

FIG. 11 is a diagram schematically illustrating another example of the data processing system including the memory system in accordance with the present embodiment.

Referring to FIG. 11, the data processing system 6200 may include a memory device 6230 having one or more nonvolatile memories and a memory controller 6220 for controlling the memory device 6230. The data processing system 6200 illustrated in FIG. 11 may serve as a storage medium such as a memory card (CF, SD, micro-SD or the like) or USB device as described with reference to FIG. 1. The memory device 6230 may correspond to the memory device 150 described in reference to FIGS. 1-9, and the memory controller 6220 may correspond to the controller 130 described in reference to FIGS. 1-9.

The memory controller 6220 may control a read, write or erase operation on the memory device 6230 in response to a request of the host 6210, and the memory controller 6220 may include one or more CPUs 6221, a buffer memory such as RAM 6222, an ECC circuit 6223, a host interface 6224 and a memory interface such as an NVM interface 6225.

The CPU 6221 ay control overall operations on the memory device 6230, for example, read, write, file system management and bad page management operations. The RAM 6222 may be operated according to control of the CPU 6221, and used as a work memory, buffer memory or cache memory. When the RAM 6222 is used as a work memory, data processed by the CPU 6221 may be temporarily stored in the RAM 6222. When the RAM 6222 is used as a buffer memory, the RAM 6222 may be used for buffering data transmitted to the memory device 6230 from the host 6210 or transmitted to the host 6210 from the memory device 6230. When the RAM 6222 is used as a cache memory, the RAM 6222 may assist the low-speed memory device 6230 to operate at high speed.

The ECC circuit 6223 may correspond to the ECC unit 138 of the controller 130 illustrated in FIG. 1. As described with reference to FIG. 1, the ECC circuit 6223 may generate an ECC (Error Correction Code) for correcting a fail bit or error bit of data provided from the memory device 6230. The ECC circuit 6223 may perform error correction encoding on data provided to the memory device 6230, thereby forming data with a parity bit. The parity bit may be stored in the memory device 6230. The ECC circuit 6223 may perform error correction decoding on data outputted from the memory device 6230. At this time, the ECC circuit 6223 may correct an error using the parity bit. For example, as described with reference to FIG. 1, the ECC circuit 6223 may correct an error using the LDPC code, BCH code, turbo code, Reed-Solomon code, convolution code, RSC or coded modulation such as TCM or BCM.

The memory controller 6220 may transmit/receive data to/from the host 6210 through the host interface 6224, and transmit/receive data to/from the memory device 6230 through the NVM interface 6225. The host interface 6224 may be connected to the host 6210 through a PATA bus SATA bus, SCSI, USB, PCIe or NAND interface. The memory controller 6220 may have a wireless communication function with a mobile communication protocol such as WiFi or Long Term Evolution (LTE). The memory controller 6220 may be connected to an external device, for example, the host 6210 or another external device, and then transmit/receive data to/from the external device. In particular, as the memory controller 6220 is configured to communicate with the external device through one or more of various communication protocols, the memory system and the data processing system in accordance with the present embodiment may be applied to wired/wireless electronic devices or particularly a mobile electronic device.

FIG. 12 is a diagram schematically illustrating another example of the data processing system including the memory system in accordance with the present embodiment. FIG. 12 schematically illustrates an SSD to which the memory system in accordance with the present embodiment is applied.

Referring to FIG. 12, the SSD 6300 may include a controller 6320 and a memory device 6340 including a plurality of nonvolatile memories. The controller 6320 may correspond to the controller 130 described with reference of FIGS. 1 to 9, and the memory device 6340 may correspond to the memory device 150 in the memory system of FIGS. 1 to 9.

More specifically, the controller 6320 may be connected to the memory device 6340 through a plurality of channels CH to CHi. The controller 6320 may include one or more processors 6321, a buffer memory 6325, an ECC circuit 6322, a host interface 6324 and a memory interface, for example, a nonvolatile memory interface 6326.

The buffer memory 6325 may temporarily store data provided from the host 6310 or data provided from a plurality of flash memories NVM included in the memory device 6340, or temporarily store meta data of the plurality of flash memories NVM, for example, map data including a mapping table. The buffer memory 6325 may be embodied by volatile memories such as DRAM, SDRAM, DDR SDRAM, LPDDR SDRAM and GRAM or nonvolatile memories such as FRAM, ReRAM, STT-MRAM and PRAM. For convenience of description, FIG. 11 illustrates that the buffer memory 6325 exists in the controller 6320. However, the buffer memory 6325 may exist outside the controller 6320.

The ECC circuit 6322 ray calculate an ECC value of data to be programmed to the memory device 6340 during a program operation, perform an error correction operation on data read from the memory device 6340 based on the ECC value during a read operation, and perform an error correction operation on data recovered from the memory device 6340 during a failed data, recovery operation.

The host interface 6324 may provide an interface function with an external device, for example, the host 6310, and the nonvolatile memory interface 6326 may provide an interface function with the memory device 6340 connected through the plurality of channels.

Furthermore, a plurality of SSDs 6300 to which the memory system 110 of FIGS. 1 and 5 is applied may be provided to embody a data processing system, for example, RAID (Redundant Array of Independent Disks) system. At this time, the RAID system may include the plurality of SSDs 6300 and a RAID controller for controlling the plurality of SSDs 6300. When the RAID controller performs a program operation in response to a write command provided from the host 6310, the RAID controller may select one or more memory systems or SSDs 6300 according to a plurality of RAID levels, that is, RAID level information of the write command provided from the host 6310 in the SSDs 6300, and output data corresponding to the write command to the selected SSDs 6300. Furthermore, when the RAID controller performs a read command in response to a read command provided from the host 6310, the RAID controller may select one or more memory systems or SSDs 6300 according to a plurality of RAID levels, that is, RAID level information of the read command provided from the host 6310 in the SSDs 6300, and provide data read from the selected SSDs 6300 to the host 6310.

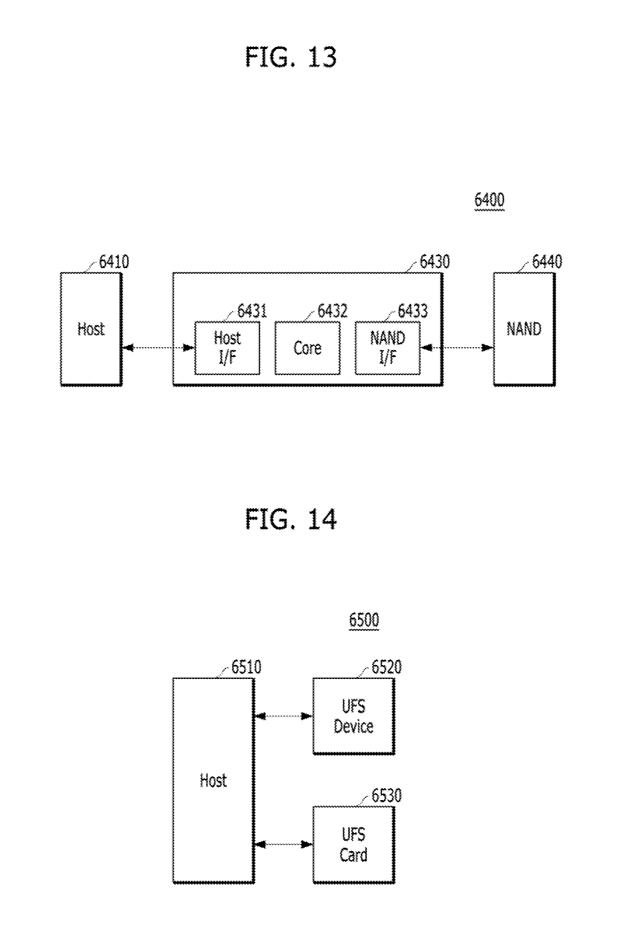

FIG. 13 is a diagram schematically illustrating another example of the data processing system including the memory system in accordance with the present embodiment. FIG. 13 schematically illustrates an embedded Multi-Media Card (eMMC) to which the memory system in accordance with the present embodiment is applied.

Referring to FIG. 13, the eMMC 6400 may include a controller 6430 and a memory device 6440 embodied by one or more NAND flash memories. The controller 6430 may correspond to the controller 130 of FIGS. 1 to 9, and the memory device 6440 may correspond to the memory device 150 of FIGS. 1 to 9.

More specifically, the controller 6430 may be connected to the memory device 6440 through a plurality of channels. The controller 6430 may include one or more cores 6432, a host interface 6431 and a memory interface, for example, a NAND interface 6433.

The core 6432 may control overall operations of the eMMC 6400, the host interface 6431 may provide an interface function between the controller 6430 and the host 6410, and the NAND interface 6433 may provide an interface function between the memory device 6440 and the controller 6430. For example, the host interface 6431 may serve as a parallel interface, for example, MMC interface as described with reference to FIG. 1. Furthermore, the host interface 6431 may serve as a serial interface, for example, UHS (Ultra High Speed)-I/UHS-II) interface.

FIGS. 14 to 17 are diagrams schematically illustrating other examples of the data processing system including the memory system in accordance with the present embodiment. FIGS. 14 to 17 schematically illustrate UFS (Universal Flash Storage) systems to which the memory system in accordance with the present embodiment is applied.

Referring to FIGS. 14 to 17, the UFS systems 6500, 6600, 6700 and 6800 may include hosts 6510, 6610, 6710 and 6810, UFS devices 6520, 6620, 6720 and 6820 and UFS cards 6530, 6630, 6730 and 6830, respectively. The hosts 6510, 6610, 6710 and 6810 may serve as application processors of wired/wireless electronic devices or particularly mobile electronic devices, the UFS devices 6520, 6620, 6720 and 6820 may serve as embedded UFS devices, and the UFS cards 6530, 6630, 6730 and 6830 may serve as external embedded UFS devices or removable UFS cards.

The hosts 6510, 6610, 6710 and 6810, the UFS devices 6520, 6620, 6720 and 6820 and the UFS cards 6530, 6630, 6730 and 6830 in the respective UFS systems 6500, 6600, 6700 and 6800 may communicate with external devices, for example, wired/wireless electronic devices or particularly mobile electronic devices through UFS protocols, and the UFS devices 6520, 6620, 6720 and 6820 and the UFS cards 6530, 6630, 6730 and 6830 may be embodied by the memory system 110 described in reference to FIGS. 1-9. For example, in the UFS systems 6500, 6600, 6700 and 6800, the UFS devices 6520, 6620, 6720 and 6820 may be embodied In the form of the data processing system 6200, the SSD 6300 or the eMMC 6400 described with reference to FIGS. 11 to 13, and the UFS cards 6530, 6630, 6730 and 6830 may be embodied in the form of the memory card system 6100 described with reference to FIG. 10.

Furthermore, in the UFS systems 6500, 6600, 6700 and 6800, the hosts 6510, 6610, 6710 and 6810, the UFS devices 6520, 6620, 6720 and 6820 and the UFS cards 6530, 6630, 6730 and 6830 may communicate with each other through an UFS interface, for example, MIPI M-PHY and MIPI UniPro (Unified Protocol) in MIPI (Mobile Industry Processor Interface). Furthermore, the UFS devices 6520, 6620, 6720 and 6820 and the UFS cards 6530, 6630, 6730 and 6830 may communicate with each other through various protocols other than the UFS protocol, for example, UFDs, MMC, SD, mini-SD, and micro-SD.

In the UFS system 6500 illustrated in FIG. 14, each of the host 6510, the UFS device 6520 and the UFS card 6530 may include UniPro. The host 6510 may perform a switching operation in order to communicate with the UFS device 6520 and the UFS card 6530. In particular, the host 6510 may communicate with the UFS device 6520 or the UFS card 6530 through link layer switching, for example, L3 switching at the UniPro. At this time, the UFS device 6520 and the UFS card 6530 may communicate with each other through link layer switching at the UniPro of the host 6510 In the present embodiment, the configuration in which one UFS device 6520 and one UFS card 6530 are connected to the host 6510 has been exemplified for convenience of description. However, a plurality of UFS devices and UFS cards may be connected in parallel or in the form of a star to the host 6410, and a plurality of UFS cards may be connected in parallel or in the form of a star to the UFS device 6520 or connected in series or in the form of a chain to the UFS device 6520.

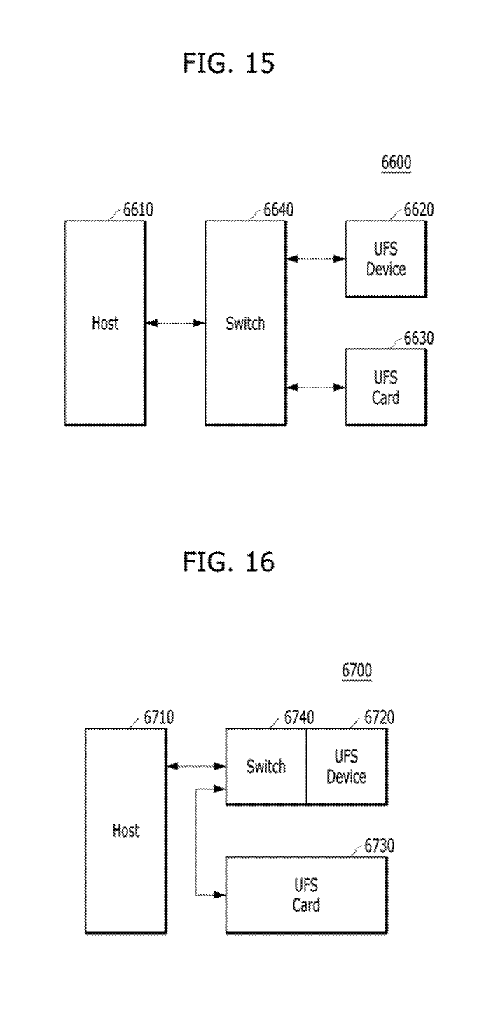

In the UFS system 6600 illustrated in FIG. 15, each of the host 6610, the UFS device 6620 and the UFS card 6630 may include UniPro, and the host 6610 may communicate with the UFS device 6620 or the UFS card 6630 through a switching module 6640 performing a switching operation, for example, through the switching module 6640 which performs link layer switching at the UniPro, for example, L3 switching. The UFS device 6620 and the UFS card 6630 may communicate with each other through link layer switching of the switching module 6640 at UniPro. In the present embodiment, the configuration in which one UFS device 6620 and one UFS card 6630 are connected to the switching module 6640 has been exemplified for convenience of description. However, a plurality of UFS devices and UFS cards may be connected in parallel or in the form of a star to the switching module 6640, and a plurality of UFS cards may be connected in series or in the form of a chain to the UFS device 6620.

In the UFS system 6700 illustrated in FIG. 16, each of the host 6710, the UFS device 6720 and the UFS card 6730 may include UniPro, and the host 6710 may communicate with the UFS device 6720 or the UFS card 6730 through a switching module 6740 performing a switching operation, for example, through the switching module 6740 which performs link layer switching at the UniPro, for example, L3 switching. At this time, the UFS device 6720 and the UFS card 6730 may communicate with each other through link layer switching of the switching module 6740 at the UniPro, and the switching module 6740 may be integrated as one module with the UFS device 6720 inside or outside the UFS device 6720. In the present embodiment, the configuration in which one UFS device 6720 and one UFS card 6730 are connected to the switching module 6740 has been exemplified for convenience of description. However, a plurality of modules each including the switching module 6740 and the UFS device 6720 may be connected in parallel or in the form of a star to the host 6710 or connected in series or in the form of a chain to each other. Furthermore, a plurality of UFS cards may be connected in parallel or in the form of a star to the UFS device 6720.

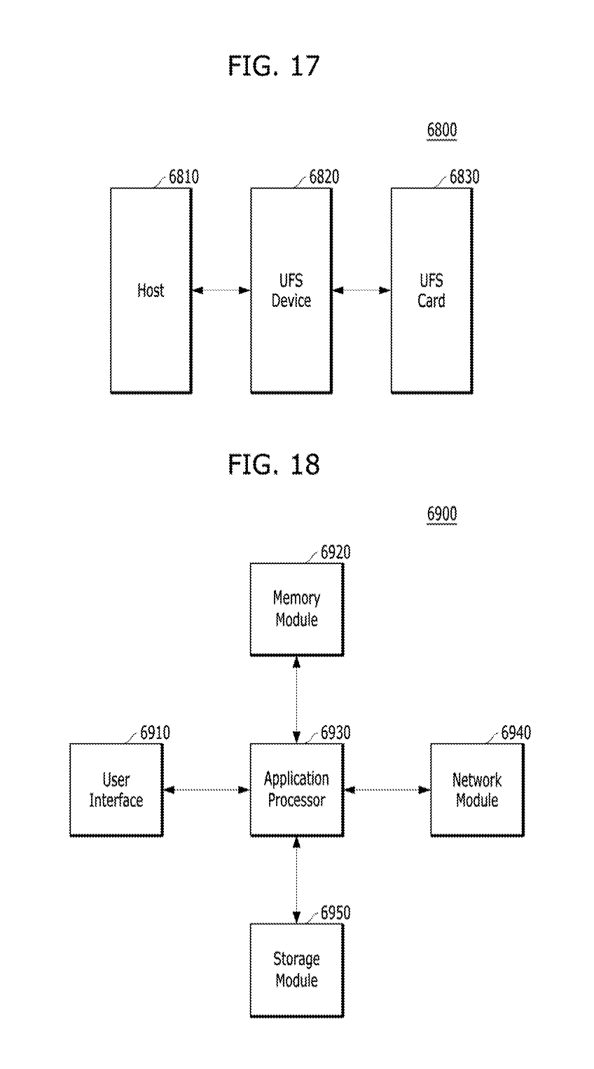

In the UFS system 6800 illustrated in FIG. 17, each of the host 6810, the UFS device 6820 and the UFS card 6830 may include M-PHY and UniPro. The UFS device 6820 may perform a switching operation in order to communicate with the host 6810 and the UFS card 6830. In particular, the UFS device 6820 may communicate with the host 6810 or the UFS card 6830 through a switching operation between the M-PHY and UniPro module for communication with the host 6810 and the M-PHY and UniPro module for communication with the UFS card 6830, for example, through a target ID (Identifier) switching operation. At this time, the host 6810 and the UFS card 6830 may communicate with each other through target ID switching between the M-PHY and UniPro modules of the UFS device 6820. In the present embodiment the configuration in which one UFS device 6820 is connected to the host 6810 and one UFS card 6830 is connected to the UFS device 6820 has been exemplified for convenience of description. However, a plurality of UFS devices may be connected in parallel or in the form of a star to the host 6810, or connected in series or in the form of a chain to the host 6810, and a plurality of UFS cards may be connected in parallel or in the form of a star to the UFS device 6820, or connected in series or in the form of a chain to the UFS device 6820.

FIG. 18 is a diagram schematically illustrating another example of the data processing system including the memory system in accordance with an embodiment of the present invention. FIG. 18 is a diagram schematically illustrating a user system to which the memory system in accordance with the present embodiment is applied.

Referring to FIG. 18, the user system 6900 may include an application processor 6930, a memory module 6920, a network module 6940, a storage module 6950 and a user interface 6910.

More specifically, the application processor 6930 may drive components included in the user system 6900, for example, an OS, and include controllers, interfaces and a graphic engine which control the components included in the user system 6900. The application processor 6930 may be provided as System-on-Chip (SoC).

The memory module 6920 may be used as a main memory, work memory, buffer memory or cache memory of the user system 6900. The memory module 6920 may include a volatile RAM such as DRAM, SDRAM, DDR SDRAM, DDR2 SDRAM, DDR3 SDRAM, LPDDR SDARM, LPDDR3 SDRAM or LPDDR3 SDRAM or a nonvolatile RAM such as PRAM, ReRAM, MRAM or FRAM. For example, the application processor 6930 and the memory module 6920 may be packaged and mounted, based on POP (Package on Package).

The network module 6940 may communicate with external devices. For example, the network module 6940 may not only support wired communication, but also support various wireless communication protocols such as code division multiple access (CDMA), global system for mobile communication (GSM), wideband CDMA (WCDMA), CDMA-2000, time division multiple access (TDMA), long term evolution (LTE), worldwide interoperability for microwave access (Wimax), wireless local area network (WLAN), ultra-wideband (UWB) Bluetooth, wireless display (WI-DI), thereby communicating with wired/wireless electronic devices or particularly mobile, electronic devices. Therefore, the memory system and the data processing system, in accordance with an embodiment of the present invention can be applied to wired/wireless electronic devices. The network module 6940 may be included in the application processor 6930.

The storage module 6950 may store data, for example, data received from the application processor 6930, and then may transmit the stored data to the application processor 6930. The storage module 6950 may be embodied by a nonvolatile semiconductor memory device such as a phase-change RAM (PRAM), a magnetic RAM (MRAM) a resistive RAM (ReRAM), a NAND flash, NOR flash and 3D NAND flash, and provided as a removable storage medium such as a memory card or external drive of the user system 6900. The storage module 6950 may correspond to the memory system 110 described with reference to FIGS. 1 and 5. Furthermore, the storage module 6950 may be embodied as an. SSD, eMMC and UFS as described above with reference to FIGS. 12 to 17.

The user interface 6910 may include interfaces for inputting data or commands to the application processor 6930 or outputting data to an external device. For example, the user interface 6910 may include user input interfaces such as a keyboard, a keypad, a button, a touch panel, a touch screen, a touch pad, a touch ball, a camera, a microphone, a gyroscope sensor, a vibration sensor and a piezoelectric element, and user output interfaces such as a liquid crystal display (LCD), an organic light emitting diode (OLED) display device, an active matrix OLED (AMOLED) display device, an LED, a speaker and a motor.

Furthermore, when the memory system 110 of FIGS. 1 and 5 is applied to a mobile electronic device of the user system 6900, the application processor 6930 may control overall operations of the mobile electronic device, and the network module 6940 may serve as a communication module for controlling wired/wireless communication with an external device. The user interface 6910 may display data processed by the processor 6930 on a display/touch module of the mobile electronic device, or support function of receiving data from the touch panel.

The memory system and the operating method thereof according to the embodiments may minimize complexity and performance deterioration of the memory system and maximize use efficiency of a memory device, thereby quickly and stably process data with respect to the memory device.

Although various embodiments have been described for illustrative purposes, it will be apparent to those skilled in the art that various changes and modifications may be made without departing from the spirit and scope of the invention as defined in the following claims.

What is claimed is:

1. A memory system comprising:
a memory device; and
a controller suitable for;
performing command operations; predicting peak operation durations for each of the command operations when performing the command operations; and
scheduling the command operations by minimizing overlaps between the peak operation durations of the command operations.

2. The memory system according to claim 1, wherein the controller is suitable for scheduling the command operations in a manner that the command operations are performed to the memory device with different pending times.

3. The memory system according to claim 2, wherein the pending times correspond to prime numbers times a reference clock of the memory system.

4. The memory system according to claim 1, wherein the peak operation durations are operation durations in which the command operations are performed within at least one of a peak power level and voltage/current level, a peak operation clock and a peak temperature level.

5. The memory system according to claim 1, wherein the controller checks the respective command operations, checks respective sub command operations in the respective command operations, and checks respective peak sub command operations among the sub command operations of the respective command operations.

6. The memory system according to claim 5, wherein the peak operation durations are operation durations in which the peak sub command operations are respectively performed to the memory device.

7. The memory system according to claim 5, wherein the controller schedules the commands such that the peak sub command operations are performed to the memory device for different operation durations.

8. The memory system according to claim 1, herein the controller schedules the commands such that the command operations are performed within a maximum usable power level and voltage/current level, a maximum operation clock and a maximum temperature level in the memory system.

9. The memory system according to claim 1, wherein the controller groups the memory dies into a plurality of memory die groups, and schedules the commands such that the command operations are performed with different pending times among the memory die groups or among memory dies in the memory die groups.

10. The memory system according to claim 1, wherein the memory die groups include memory dies which are grouped in correspondence to at least ones among channels, ways, memory block types and data types.

11. A method for operating a memory system, comprising:
receiving a plurality of commands for a memory device;
predicting peak operation durations when performing command operations;
scheduling the commands to minimize overlaps between the peak operation durations; and
performing the respective command operations to the memory device.

12. The method according to claim 11, wherein the scheduling schedules the commands such that the command operations are performed to the memory device with different pending times.

13. The method according to claim 12, wherein the pending times correspond to prime numbers times a reference dock of the memory system.

14. The method according to claim 11, wherein the peak operation durations are operation durations in which the command operations are performed within at least one of a peak power level and voltage/current level, a peak operation dock and a peak temperature level.

15. The method according to claim 11, further comprising:
checking the respective command operations;
checking respective sub command operations in the respective command operations; and
checking respective peak sub command operations among the sub command operations of the respective command operations.

16. The method according to claim 15, wherein the peak operation durations are operation durations in which the peak sub command operations are respectively performed to the memory device.

17. The method according to claim 15, wherein the scheduling schedules the commands such that the peak sub command operations are performed to the memory device for different operation durations.

18. The method according to claim 11, wherein the scheduling schedules the commands such that the command operations are performed within a maximum usable power level and voltage/current level, a maximum operation dock and a maximum temperature level in the memory system.

19. The method according to claim 11, further comprising:
grouping the memory dies into a plurality of memory die groups; and
scheduling the commands such that the command operations are performed with different pending times among the memory die groups or among memory dies in the memory die groups.

20. The method according to claim 11, wherein the memory die groups include memory dies which are grouped in correspondence to at least ones among channels, ways, memory block types and data types.
